(19) United States
(12) Patent Application Publication
(10) Pub. No.: US 2024/0297598 A1
(43) Pub. Date: Sep. 5, 2024

(54) MULTIMODE CONTROL OF HF LINK UNIVERSAL MINIMAL CONVERTERS (UMC)

(71) Applicant: Georgia Tech Research Corporation, Atlanta, GA (US)

(72) Inventors: Deepak M. Divan, Atlanta, GA (US); Joseph Benzaquen Sune, Atlanta, GA (US); Ruomu Hao, Atlanta, GA (US)

(21) Appl. No.: 18/594,917

(22) Filed: Mar. 4, 2024

Related U.S. Application Data
(60) Provisional application No. 63/488,134, filed on Mar. 2, 2023.

(51) Int. Cl. H02M 7/797; H02M 3/335

(52) U.S. Cl. CPC H02M 7/797; H02M 3/335

(57) ABSTRACT

Embodiments of the present disclosure include universal minimal converter comprising power converter circuits and controllers that can perform optimized control of power converters to implement multimodal control schemes using pre-defined set of modes in the control cycles on a cycle-by-cycle basis. The topology of the exemplary system provides for an optimized set of hardware and equipment that reduces or provide for a low cost implementation. The control of the exemplary system extends the hardware and equipment in a universal manner for a plurality of operational modes.

### RELATED APPLICATION

This application claims priority to, and the benefit of, U.S. Provisional Patent Application No. 63/488,134, filed Mar. 2, 2023, entitled “MULTIMODE CONTROL OF HF LINK UNIVERSAL MINIMAL CONVERTERS (UMC),” which is incorporated by reference herein in its entirety.

### TECHNICAL FIELD

This application is directed to power converter system and its controls.

### BACKGROUND

Power converters convert one form of electrical power into another form of electrical power. Example power converters include DC-DC converters, DC-AC converters, and AC-DC. Power converters allow for power generators, power consumers, and power storage systems to have different voltages and current inputs/outputs from one another. As an example, power is often transmitted in high voltage AC systems, but renewable resources like photovoltaics output low voltage DC power. Power converters can be used to solve this and other problems.

Power system are typically defined in a customed manner for a given hardware and device topologies. Controls of the power system equipment are rigidly implemented to a specific operational mode, e.g., as a buck, boost, converter, AC-AC, AC-DC, DC-AC, DC-DC, etc.

There are benefits to systems and methods for improving the controls of power converters.

### SUMMARY

An exemplary universal minimal converter and method are disclosed for a power electronic system controller that define a universal, minimal unit cell converter within a number of potential power converter circuit to which a universal multimodal control scheme can be applied to the unit cell. The universal multimodal control scheme operates allows multimodal operation, e.g., AC/AC, DC/AC, AC/DC, and DC/DC power conversion as well as microgrids, to be executed for any number of power converter circuits. As used herein, “AC” can refer to any alternating current system, including but not limited to single phase AC, slip-phase, three-phase AC systems.

The universal multimodal control scheme provides a number of pre-defined set of modes for a given energy transfer cycle to be performed by the universal, minimal unit cell converter to which the modes can be selected per cycle to provide control of the power circuit in a cycle-on-cycle basis.

The term “universal” refers to the capability of the example unit cell in providing, via its control, controls for AC/AC, DC/AC, AC/DC, and DC/DC power conversion. The term “universal” also refers to the unit cell being mappable to any number of physical power converters having different topologies and configurations. To this end, the universal, minimal unit cell converter and its associated controls may be used ubiquitously in new standalone installation as well as retrofit systems for new or existing power converter infrastructure. The exemplary disclosure may be employed in a vehicle, hybrid vehicle, or electric vehicle, or in a structure (e.g., residence, commercial, industrial, etc.) to provide power connectivity to virtually any other power structure, e.g., to connect to the DC battery on the vehicle, connect to a DC fast charger, AC fast charger, connect to the grid, three-phase grid. It can also flexibly form a micro grid, support load, among other functions described herein, as a low-cost power electronic package that leverages available energy storage in a vehicle or building structure. In some embodiments, the system is configured for standalone installation, retrofit system, e.g., after market install in the garage. In some embodiments, the system is configured as an integrated onboard vehicle power system. In either scenario, the exemplary systems can provide additional functionality noted herein as a universal minimal converter. In some embodiments, multiple vehicles (e.g., military, emergency systems) can be tethered through the system, as a universal power system cell, to form a microgrid for temporary, portable, or emergency power grid. In some embodiments, the system can be used in buses or large vehicles to provide power resilience for a building (e.g., school building, storm shelters, community centers, and the like).

As an example, the power system of an existing and manufactured vehicle having an electronic power system with a compliant power system circuit topology, e.g., for AC to DC conversion, can be reprogrammed so that its controller is retrofitted with exemplary control software that operates the existing power system circuit topology with a number of multi-mode operations, including AC to DC conversion, and DC to DC conversion.

The exemplary system had a DC side and a 3-phase AC side that is coupled by a transformer or energy device. The system has a switching frequency preferably greater than 15 kHz, e.g., between 20 kHz and 30 kHz, and is preferably sized 50 Kilowatts (kW)-150 kW for home and vehicle applications. For 3-phase applications, the system can be sized for 250 or more kW.

In an aspects, a power converter is disclosed that includes: a power converter circuit including a plurality of switches and an energy transfer device (e.g., transformer and/or inductor); a controller operably coupled to the power converter circuit, the controller configured to: determine operation of a unit cell defined by the plurality of switches or a portion thereof, the unit cell including first side switches and second side switches coupled together by the energy transfer device; select (e.g., by a processor or electric circuit), from a pre-defined set of modes, a mode for a cycle that transfers a controlled charge and energy between the first side and the second side, each mode of the pre-defined set of modes having a unique combination of a plurality durations for energy transfer for a corresponding transfer condition (e.g., peak current (Ip)); and determine operation of the plurality of switches from the selected mode; and control the plurality of switches to operate the converter circuit according to the mode on a cycle-by-cycle basis, wherein a transition from a current cycle to a next cycle occurs when there is no residual energy in the energy transfer device.

In some embodiments, the controller is configured to select the mode according to a pre-defined set of sequences based on different operating conditions of the energy transfer.

In some embodiments, the selection is based on state logic.

In some embodiments, the unit cell includes a dual active bridge, wherein a primary voltage and a secondary voltage of the active bridges are switched by action of the first side switches and the second side switches.

In some embodiments, each mode of the pre-defined set of modes has a unique combination of a plurality durations for energy transfer for a corresponding transfer condition (e.g., peak current (Ip)) defined by a geometric waveform (e.g., one or more positive or inverted triangular or trapezoidal waveforms) defined by the plurality durations and the transfer condition.

In some embodiments, the pre-defined set of sequences includes analytical formulation for the different operating conditions, including at least one of output current, switching period, rms currents, and device losses.

In some embodiments, each cycle is self-contained and decoupled from another cycle.

In some embodiments, the modes are selected for minimization of peak current, and wherein each mode includes a unique combination of a plurality durations for energy transfer for a corresponding transfer condition including peak current of the energy transfer.

In some embodiments, the power converter circuit is configured as a universal minimal converter.

In some embodiments, the unit cell is universally configurable and reconfigurable as an AC/DC converter, a DC-DC converter, and a DC/AC converter, and wherein the controller and power converter circuit are configurable and reconfigurable as an AC/DC converter, a DC-DC converter, and a DC/AC converter.

In another aspect, a method is disclosed including: determining operation of a unit cell defined by the plurality of switches or a portion thereof of a power converter circuit including a plurality of switches and an energy transfer device (e.g., transformer and/or inductor), the unit cell including first side switches and second side switches coupled together by the energy transfer device; selecting, from a pre-defined set of modes, a mode for a cycle that transfers a controlled charge and energy between the first side and the second side, each mode of the pre-defined set of modes having a unique combination of a plurality durations for energy transfer for a corresponding transfer condition (e.g., peak current (Ip)); and determining operation of the plurality of switches from the selected mode; and controlling the plurality of switches to operate the converter circuit according to the mode on a cycle-by-cycle basis, wherein a transition from a current cycle to a next cycle occurs when there is no residual energy in the energy transfer device.

In some embodiments, the selecting of the mode is according to a pre-defined set of sequences based on different operating conditions of the energy transfer.

In some embodiments, the selection is based on state logic.

In some embodiments, the unit cell includes a dual active bridge, wherein a first voltage and a second voltage of the active bridges are switched by action of the first side switches and the second side switches.

In some embodiments, each mode of the pre-defined set of modes has a unique combination of a plurality durations for energy transfer for a corresponding transfer condition (e.g., peak current (Ip)) defined by a geometric waveform (e.g., one or more positive or inverted triangular or trapezoidal waveforms) defined by the plurality durations and the transfer condition.

In some embodiments, the pre-defined set of sequences includes analytical formulation for the different operating conditions, including at least one of output current, switching period, rms currents, and device losses.

In some embodiments, the modes are selected for minimization of peak current, and wherein each mode includes a unique combination of a plurality durations for energy transfer for a corresponding transfer condition including peak current of the energy transfer.

In some embodiments, the power converter circuit includes a transformer as the energy transfer device.

In some embodiments, the unit cell is universally configurable and reconfigurable as an AC/DC converter, a DC-DC converter, and a DC/AC converter, and wherein the controller and power converter circuit are configurable and reconfigurable as an AC/DC converter, a DC-DC converter, and a DC/AC converter.

In another aspects, a non-transitory computer readable medium is disclosed having instruction stored thereon, wherein execution of the instructions by a processor causes the processor to: determine operation of a unit cell defined by the plurality of switches or a portion thereof of a power converter circuit including a plurality of switches and an energy transfer device (e.g., transformer and/or inductor), the unit cell including first side switches and second side switches coupled together by the energy transfer device; select, from a pre-defined set of modes, a mode for a cycle that transfers a controlled charge and energy between the first side and the second side, each mode of the pre-defined set of modes having a unique combination of a plurality durations for energy transfer for a corresponding transfer condition (e.g., peak current (Ip)); determine operation of the plurality of switches from the selected mode; and controlling the plurality of switches to operate the converter circuit according to the selected mode on a cycle-by-cycle basis, wherein a transition from a current cycle to a next cycle occurs when there is no residual energy in the energy transfer device.

### BRIEF DESCRIPTION OF THE DRAWINGS

The skilled person in the art will understand that the drawings described below are for illustration purposes only.

FIG. 1 shows an example system including a power converter, controller, and example current waveforms according to different modes, in accordance with illustrative embodiments.

FIG. 2A illustrates an example isolated universal minimum converter (UMC) cell structure, in accordance with illustrative embodiments.

FIG. 2B illustrates an example non-isolated UMC cell structure, in accordance with illustrative embodiments.

FIGS. 3A-3E illustrate example modes of operation of an example UMC cell, in accordance with illustrative embodiments.

FIG. 3A illustrates an example first mode of the example UMC cell.

FIG. 3B illustrates an example second mode of the example UMC cell.

FIG. 3C illustrates an example third mode of the example UMC cell.

FIG. 3D illustrates an example fourth mode of the example UMC cell.

FIG. 3E illustrates an example fifth mode of the example UMC cell.

FIG. 4A illustrates a plot of frequency vs V₀/V including UMC cell operating regions, in accordance with illustrative embodiments.

FIG. 4B illustrates a plot of Iₚ/A including UMC cell operating regions, in accordance with illustrative embodiments.

FIG. 5A illustrates an example isolated DC/AC three-phase implementation of a UMC, and an example method of UMC control, in accordance with illustrative embodiments.

FIG. 5B illustrates an example plot of a space-vector pulse-width-modulation (SVPWM) in a 3-phase DC-AC embodiment and an example plot of HF-link current using multimode control, in accordance with illustrative embodiments.

FIG. 6A illustrates an example circuit implementing a 3-phase AC-AC power converter, in accordance with illustrative embodiments.

FIG. 6B illustrates an example circuit implementing a multi-port DC-AC (3-phase) power converter, in accordance with illustrative embodiments.

FIG. 6C illustrates an example circuit implementing a DC-AC 3-phase microinverter, in accordance with illustrative embodiments.

FIGS. 7A-7D show example universal minimal converters (UMC's).

FIG. 7A shows an example power converter circuit configured for AC/DC conversion, in accordance with illustrative embodiments.

FIG. 7B shows an example power converter circuit configured for DC/DC conversion, in accordance with illustrative embodiments.

FIG. 7C shows an example power converter circuit configured for DC/AC conversion, in accordance with illustrative embodiments.

FIG. 7D shows an example power converter circuit configured for AC/AC conversion, in accordance with illustrative embodiments.

FIG. 8A illustrates an example UMC unit cell that can be used with the UMC's illustrated in FIGS. 7A-7D, for example.

FIG. 8B illustrates an example multimode control scheme and power cycle, in accordance with illustrative embodiments.

FIGS. 8C-8G illustrate example modes of a UMC unit cell shown in FIG. 8A, in accordance with illustrative embodiments.

FIG. 8C illustrates a first example mode of a UMC unit cell shown in FIG. 8A.

FIG. 8D illustrates a second example mode of a UMC unit cell shown in FIG. 8A.

FIG. 8E illustrates a third example mode of a UMC unit cell shown in FIG. 8A.

FIG. 8F illustrates a fourth example mode of a UMC unit cell shown in FIG. 8A.

FIG. 8G illustrates a fifth example mode of a UMC unit cell shown in FIG. 8A.

FIG. 9A illustrates plots of peak current Iₚ values over different vₒ/vₛ ratios for different modes.

FIG. 9B illustrates a flowchart of an example runtime control for the multimode control selection operation, in accordance with illustrative embodiments.

FIG. 9C illustrates simulation results showing waveforms for vₚᵣᵢ, v_{sec}, and iₗₖ with the selected modes for three scenarios with different values of v₀.

FIG. 10 illustrates a 2 kW UMC, in accordance with illustrative embodiments.

FIG. 11 illustrates tests results of a UMC-unit cell showing primary side voltage, secondary side voltage, inductor current, and output voltage, including per-switch cycle views of mode 5 and mode 1.

FIG. 12 illustrates an example UMC converter and control method configured for three-phase DC/AC conversion, in accordance with illustrative embodiments.

FIGS. 13A-13F illustrate an example UMC unit cell and characteristic waveforms of the three-phase UMC converter, in accordance with illustrative embodiments.

FIG. 13A illustrates an example three-phase UMC unit cell, in accordance with illustrative embodiments.

FIGS. 13B-13F illustrates an example mode waveform 1, 2, 3, 4, and 5, respectively, for the three-phase UMC unit cell.

FIGS. 14A-14C illustrate example equivalent circuits of a three-phase UMC-unit cell for one mode at three different time intervals, in accordance with illustrative embodiments.

FIG. 15 illustrates an example space vector diagram and characteristic waveform, that can be generated based on a selected mode, in accordance with illustrative embodiments.

FIG. 16 illustrates simulation results showing for three-phase UMC unit cell.

FIG. 17 illustrates experimental results for three-phase UMC unit cell.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entireties and to the same extent as if each reference was individually incorporated by reference.

### Example Universal Minimal Converter

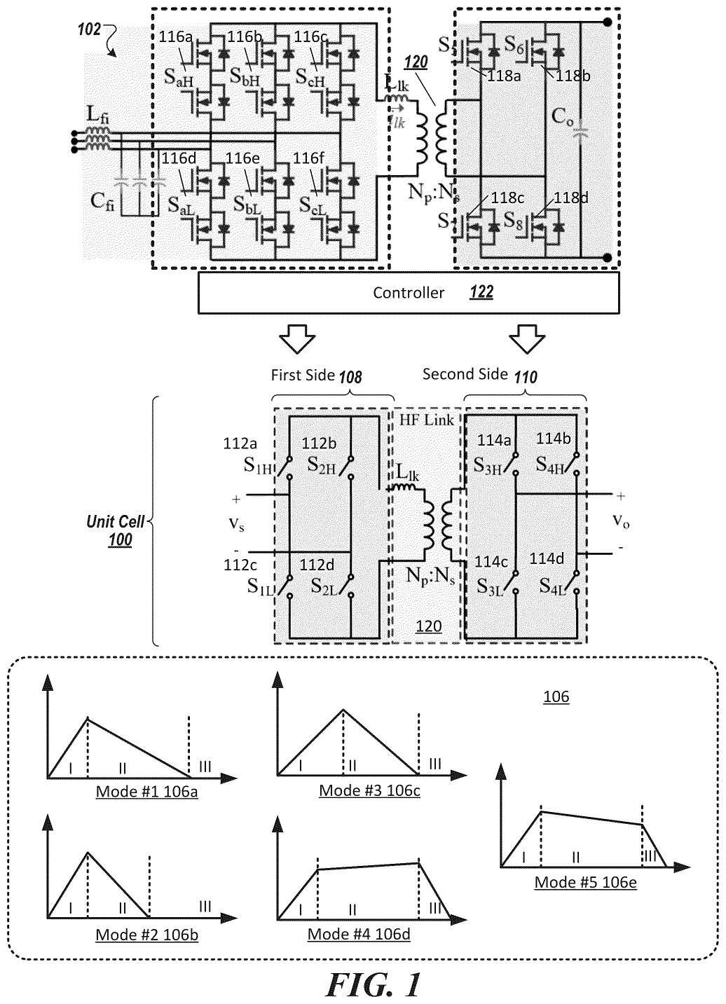

FIG. 1 shows an exemplary universal minimal converter 100 as a universal, minimal unit cell (shown as unit cell 100) that can be defined within one of a number of potential power converter circuits 102 to which a universal multimodal control scheme 106 can be applied to the unit cell 100. In the example shown in FIG. 1, the unit cell includes a first side 108 and a second side 110 each having a set of virtual switches (shown as 112a-112d and 114a-114d) that are defined from physical switches 116a-116f and 118a-118d of a power circuit. The same unit cell 100 can be universally mapped to other power circuits (e.g., 700, 720, 750, 770, among others described herein).

The universal multimodal control scheme operates to allow multimodal operation, e.g., AC/AC, DC/AC, AC/DC, and DC/DC power conversion as well as microgrids, to be executed for any number of power converter circuits.

In the example shown in FIG. 1, the power converter 102 includes a physical power converter circuit 102 comprising a plurality of switches (e.g., 116, 118) and an energy transfer device 120 (e.g., transformer and/or inductor) that operates with a controller 122. The controller 122 executes a model that redefines the physical power converter circuit as the unit cell 100 comprises the first side 108 of switches 112 and the second side 110 of switches 114. The controller additionally stores pre-defined modes 106 (shown mode #1 106a, mode #2 106b, mode #3 106c, mode #4 106d, and mode #5 106e) to operate the virtual switches 112, 114 mapped to physical switches 116, 118.

The controller 122 (e.g., by a processor or electric circuit) is configured to determine operation of the unit cell 100 by selecting a mode 106 from a pre-defined set of modes 106a-16e for each transfer cycle that transfers a controlled charge and energy between the first side 108 and the second side 110. As shown in FIG. 1, each mode 106a-106e is a unique combination of a plurality durations for energy transfer (shown as “I”, “II”, and “III”) for a corresponding transfer condition (e.g., peak current (Iₚ)). The modes are selected for a given cycle on a cycle-by-cycle basis in which the transition from a current cycle to a next cycle occurs when there is no residual energy in the energy transfer device 120. The modes have a pre-defined set of sequences of the virtual switches 112, 114 defined in a given mode.

It should be understood that the selection of the mode by the controller can be based on the minimization and/or maximization of one or more operating parameters of the unit cell 100 or a power converter including the unit cell. As a non-limiting example, an optimization for peak current can select modes based on minimizing peak current in the unit cell 100 and/or converter including the unit cell 100, which can reduce the stresses and losses in the switches of the unit cell 100 and/or power converter.

Additional non-limiting examples of optimizations that can be performed for selecting modes include optimizing for RMS current, device losses, and any other parameter of the unit cell 100 as described with reference to the examples herein.

The controller 122 can then map the selected mode, and its associated virtual switches, to a switching pattern for the physical hardware control the plurality of switches.

The term “cycles” as used herein refers to a complete state of the energy within inductive components within the system having no current or energy. Within a power system, residual energy storage and filter elements between cycles often have coupling that is very strong and that can govern the responsiveness of the overall system. The exemplary system and method selects pre-defined set of modes in the control cycles on a cycle-by-cycle basis. In some embodiments, the exemplary system and method are calculating all modes or a subset of them in real-time for a selection. In some embodiments, the pre-defined set of modes can be retrieved or selected from a look-up table in the controller.

In some embodiments, the selection of the mode 106 is based on state logic.

In the example shown in FIG. 1, the unit cell 100 includes a dual active bridge, wherein a primary voltage and a secondary voltage of the active bridges are switched by action of the first side switches and the second side switches.

The pre-defined set of sequences comprises analytical formulation for the different operating conditions, including at least one of output current, switching period, rms currents, and device losses.

### Example Universal Minimal Converter Unit Cell

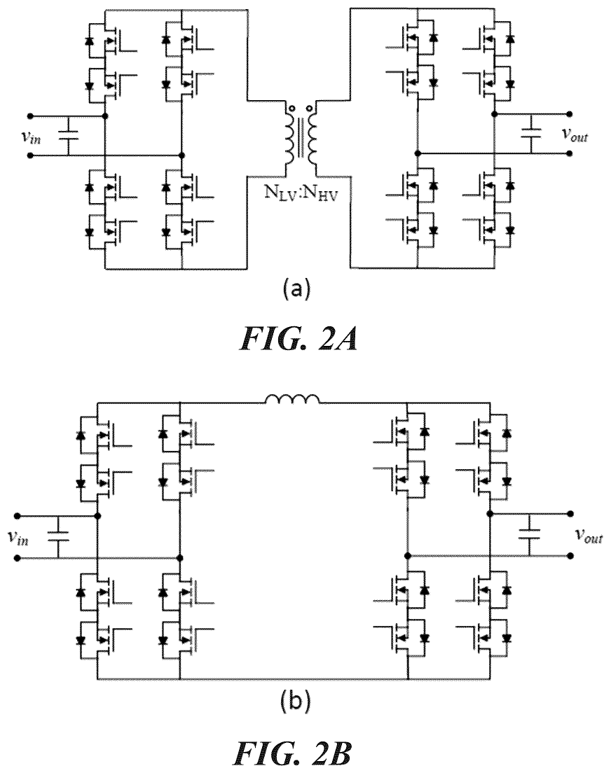

FIGS. 2A and 2B each show an exemplary multimode control structure that can reduce all minimal topology Universal Minimal Converter (UMC) converters, including without loss of generality all DC/DC, DC/AC, and AC/AC converters, to a ‘power transfer cycle’, consisting of one high-frequency switching cycle in the case of non-isolated converters, or two equal but inverted half cycles, in the case of isolated HF link converters. FIG. 2A shows an isolated UMC cell structure. FIG. 2B shows a non-isolated UMC cell structure. Either one could operate the modes described herein.

The two inverted half cycles ensure that the transformer volt-second balance is maintained and that it does not saturate due to net residual DC flux in the windings. Each cycle (including two half cycles in HF link cases) achieves net charge transfer between the primary (DC) and secondary (AC) sides of the HF transformer terminals that are connected via the switches. If it is assumed that a ‘cycle’ begins when the transformer current is zero, and that the current is again zero at the end of the ‘cycle’—we see that there is no stored energy in the energy transfer element. As a result, assuming lossless components, each cycle is a ‘bubble’ that transfers a certain ‘quantum’ of energy between the DC and AC sides. However, as the current in the transformer leakage (or series) inductance is always zero at the start and end of the ‘cycle’, there is no ‘state’ memory and there is no interaction with previous or subsequent cycles. This presumes that the DC and AC side filters are sufficiently large and provide adequate filtering, which is true by definition. This also suggests that the net charge transferred during a cycle divided by the duration of the cycle, provide the average current into or out of a terminal. This shows that the DC and AC side ports can be controlled to provide current source characteristics into a capacitive filter—realizing a first-order plant that can be easily controlled.

During a ‘cycle’ as defined above, the converter is seen as UMC (similar to a dual active bridge or DAB structure), where a primary voltage and a secondary voltage are switched by action of the primary and secondary side switches.

It can be observed from the basic switching structure that the ‘cycle’ represented a basic operating ‘quantum’ that could be used to transfer a controlled amount of charge and energy between the primary and secondary sides. It is further recognized that the multiple switch structure needed to achieve the UMC structure gave us the ability to switch the converters in different ways so as to achieve the desired charge/energy transfer objectives over a ‘cycle’. Analysis showed us that different modes of operation yielded very different level of stresses on the switches for the same level of energy transfer, particularly in cases where the DC or AC voltage could vary widely.

Because each ‘cycle’ was ‘self-contained’ and decoupled from other cycles, each cycle could be controlled in a different manner, with no degradation in converter function or controllability. This can be particularly important in the case of AC output systems where the voltage and current levels can vary widely. Through analysis, it can be observed that as the voltage is varied at which a desired level of charge transfer was to be achieved, different modes of operating a ‘cycle’ yielded very different operating characteristics and stresses. This allowed us the opportunity to optimize at the ‘cycle’ level what mode the converter should be operated in, while retaining full controllability of the plant. As a result, a multimode controller may be employed for minimal HF link converter structures, where optimum switching modes are selected for the converter on a ‘cycle’ basis, achieving both plant-level control and optimum device switching at the same time.

### Method of Operation of Universal Minimal Converter (UMC)-Cell

The UMC-cell can operate in a control approach as a DC/DC, DC/AC, and AC/AC HF link converter. The input voltage over a ‘cycle’ can be assumed to be constant DC, while the output current and voltage can vary over a range from zero to vₒ^{max} and iₒ^{max}. Desirable attributes include low losses, small size, and precise control of the output current over a range of output voltage and current. The devices can have conduction losses based on R_{ds}^{ON}. Turn-on losses can depend on the current at device turn-on, and turn-off losses on the current at turn-off.

In an example in which the peak current is controlled (which relates to rms current), frequency can be preferably set at between 20 kHz to 30 kHz. It is clear to one skilled in the art, that the same analysis could be done with any kind of semiconductor device.

The switching devices can be Si or SiC MOSFETS, IGBTs, BJTs, FETs and other power devices.

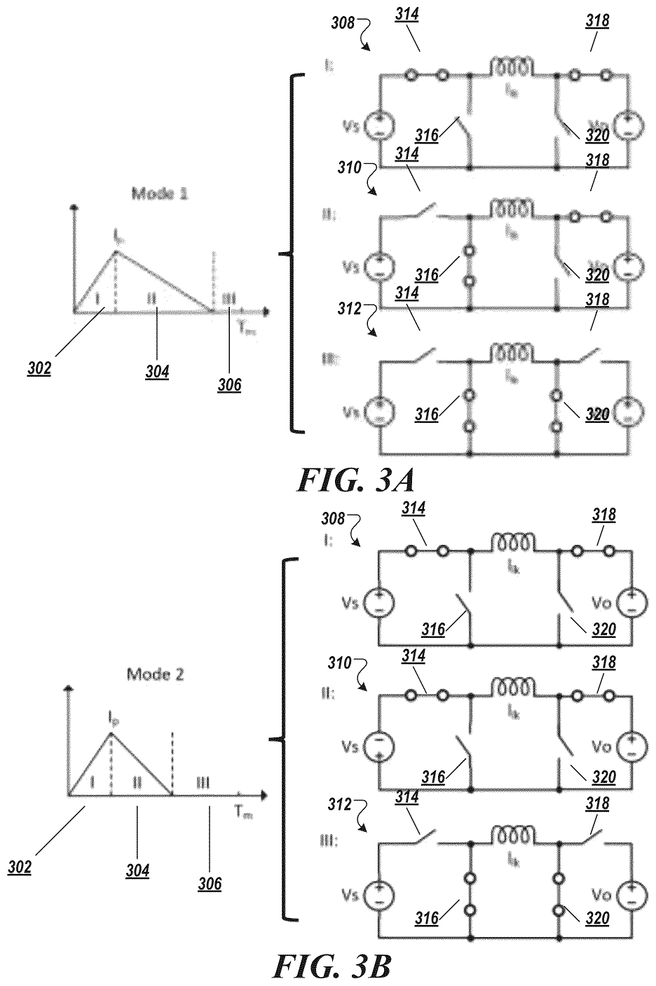

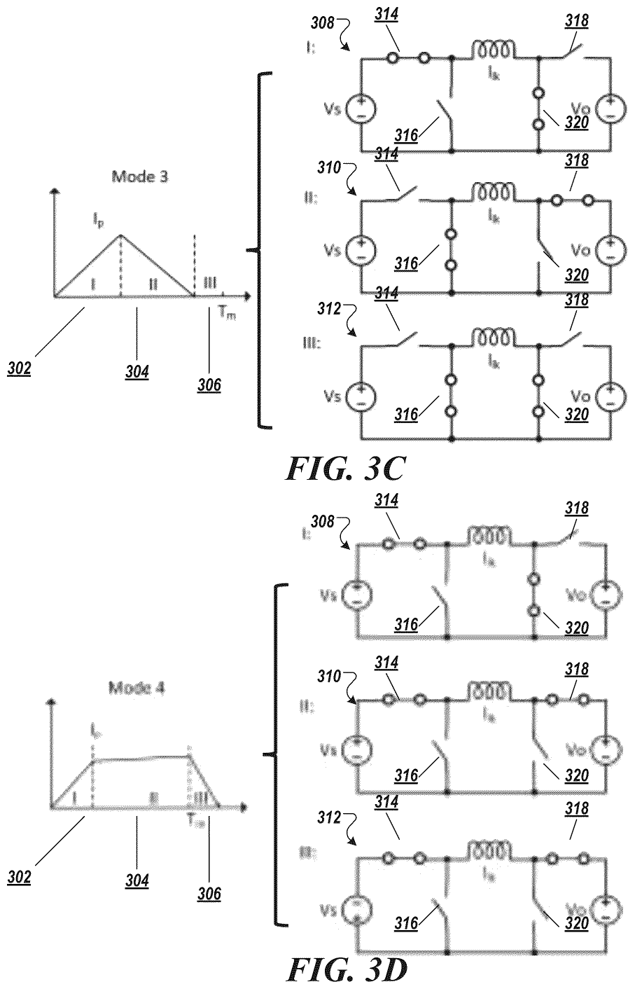

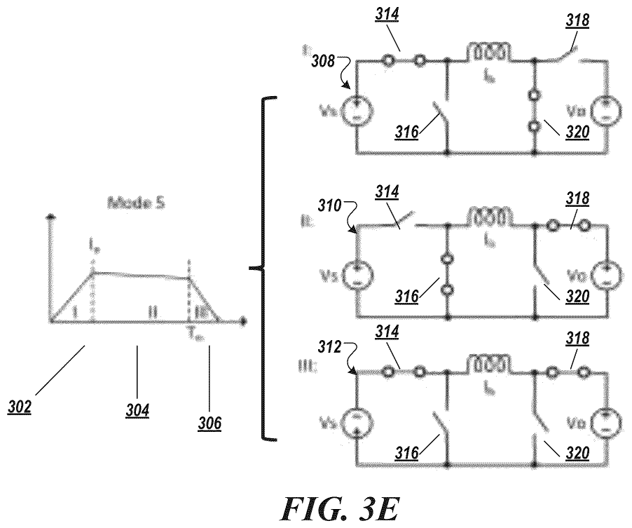

FIGS. 3A-3E show example modes for the transfer cycle. To ensure straightforward implementation of the control, in one example, two parameters can be employed: (i) value of peak transformer current Iₚ at which the conducting device is turned off (−Iₚ for the second half cycle in AC converters) and (ii) time Tₘ at which the end of the ‘cycle’ or half-cycle is initiated by the controller. To this end, the energy transfer device current pattern can be fully determined by selecting Iₚ and Tₘ for each switching cycle.

FIG. 3A-3E shows the geometrically simple triangular and trapezoidal waveforms generated for the currents during the cycle. Specifically, FIG. 3A shows the waveform for mode “1” and the sequences of switching to generate the mode waveform. FIG. 3B, 3C, 3D and 3E then show the waveforms for modes “2,” “3,” “4,” and “5” and their sequences of switching to generate the mode waveforms.

As one example, FIG. 3A shows mode “1” 106a comprising duration “I” (302), “II” (304), and “III” (306) and a set of sequences (308, 310, 312, respectively) of the switches “1” (314) and “2” (316) on the first side and switches “3” (318) and “4” (320) on the second side to provide for the waveform shown in duration “I”, “II”, and “III.” Similar examples are shown for mode “2” (FIG. 3B), mode “3” (FIG. 3C), mode “4” (FIG. 3D), and mode “5” (FIG. 3E).

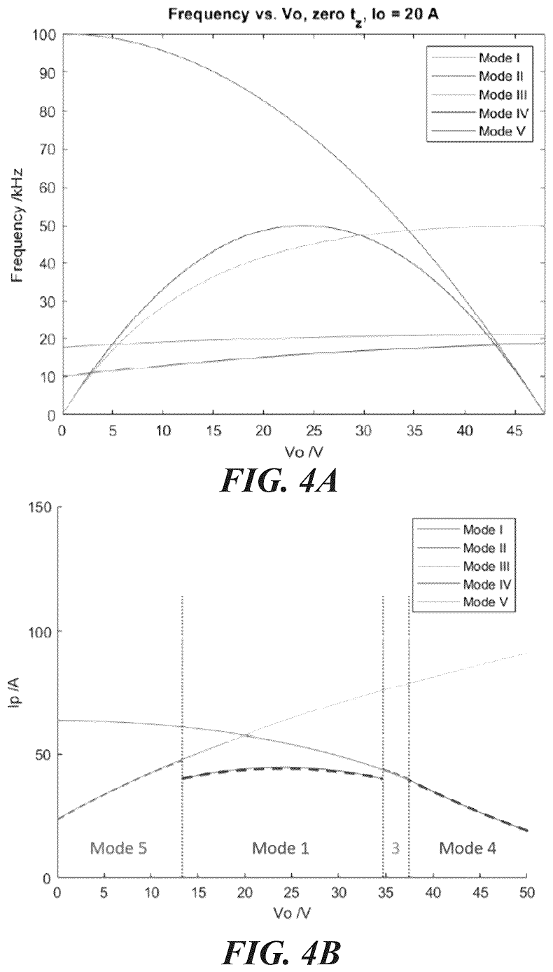

FIGS. 4A and 4B shows UMC cell operating region for each mode in terms of frequency (FIG. 4A) or peak current (FIG. 4B) as a function of the output/input voltage ratio. In FIGS. 3A-3E and FIGS. 4A and 4B, operations of the UMC-cell are shown in which the modes switches the devices at an Iₚ level and the Tₘ point, to achieve a desired Iₒ at a given Vₒ. It can be seen that for a given Vₒ/Iₒ operating point (and a given Tₘ), the best mode can be realized for the lowest Iₚ.

In other embodiments, the controller can be implemented that can compute the best mode for minimal losses in addition to another parameter. Because the analysis can be done offline, there is no limit to the level of optimization that can be implemented. The minimization of Iₚ is provided as representative parameter to demonstrate an example of the multimode control implementation and its benefits.

The UMC converter and associated controls are configured to transfer an average current of Iₒ to the secondary side over the duration of the ‘cycle’. As an example, FIGS. 3A-3E show a reduced DC/DC converter operating in buck, boost, or non-inverting buck-boost converter mode to transfer energy from Vₛ to Vₒ. Similar switching modes can be seen for all polarities of input/output voltage and power flow directionality. The ‘cycle’ are defined to begin and end at zero current.

Three distinct modes of operation (Modes 1-3). FIGS. 4A-4B show for each mode of operation the sequence of switch operation and the related primary/secondary voltage and current waveforms. The peak currents, the ‘cycle’ period, and the device stresses can be computed at a given Vs/Vo/Io operating point.

As can be seen in FIGS. 4A and 4B, the switching frequency and peak current can vary widely. At a given operating point (e.g., as defined by Vₛ/VₒIₒ), the controller can decide prior to the start of the switching ‘cycle’, which would be the most advantageous mode to operate in. As Vₒ and Iₒ vary, even over an AC cycle, the mode can be dynamically selected at the start of each ‘cycle’ to dramatically reduce device stresses, even while full controllability is maintained. Such a dynamically varying control strategy for DAB-type converter switching can realize significant benefits as an overall operating architecture and control implementation.

### DC-AC Three-Phase Operation Example

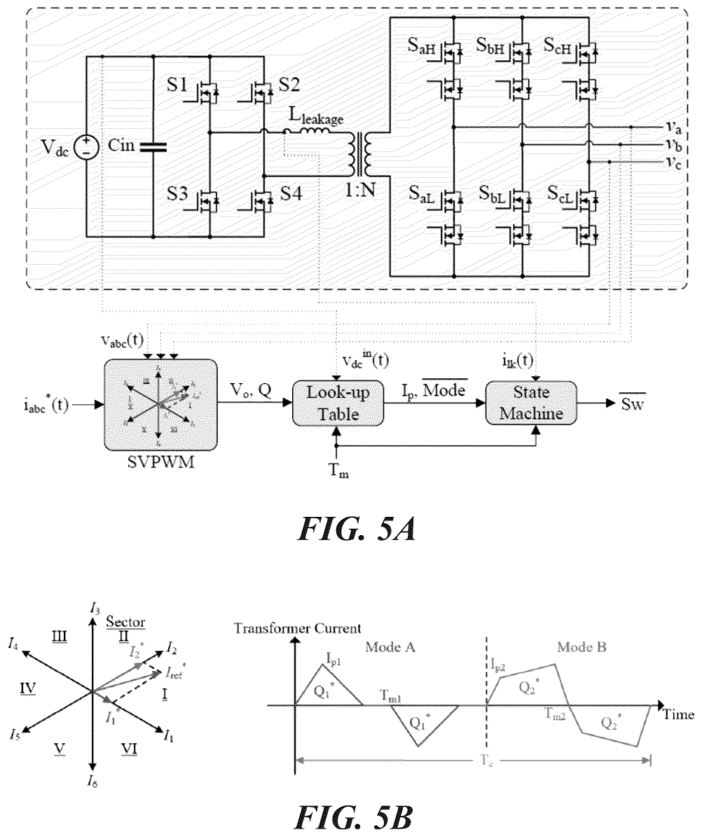

In the case of a 3-phase DC-AC implementation (see FIG. 5A), a space-vector pulse-width-modulation (SVPWM) can be adopted.

As shown in FIG. 5B, at any given time of the operation, just like a traditional SVPWM, the reference current vector generates projections along two adjacent space vectors, each representing one DC-DC UMC-cell. In each of the UMC-cell, the amount of charge to be delivered is determined by the length of the projection, and the output voltage is the line-to-line voltage corresponding to the space vector. As the reference vector rotates and changes sectors, each of the DC-DC UMC-cell will have variations in its output voltage and current, which consequently lead to changes in the operating mode and its parameters (Ip and Tm) to deliver the correct amount of charge.

FIG. 5B shows SVPWM implementation in 3-phase DC-AC embodiment based on the UMC-cell. (Left) SVPWM current vector synthetization example. (Right) UMC-cell HF-link current using multimode control.

More specifically, in this particular implementation, the lookup table, as shown in FIG. 5A, selects the operation mode that achieves the minimum peak current Ip for a given Tm, using the required charge and Vo/Vs as input parameters to the table. A second mode-specific offline-computed table is then utilized to determine the peak current that will achieve the selected charge distribution in each UMC-cell execution.

The study measured significant waveforms captured from PLECS electromagnetic transient (EMT) simulations for the 3-phase DC-AC UMC-cell-based circuit shown in FIG. 5A using the proposed multimode controller with the circuit/control parameters outlined in Table I.

TABLE I
SIMULATION PARAMETERS

| Parameter | Value | | Parameter | Value | |
|---|---|---|---|---|---|
| Power | 250 | W | Leakage Inductance | 6 | uH |
| DC Input Voltage | 48 | V | Transformer | 1:14 | |
| | | | Turns Ratio | | |
| AC Output Voltage | 240 | Vrms | Switching Frequency | 10.9 | kHz |
| LC Filter Inductance | 30.6 | mH | LC Filter Capacitance | 5 | uF |

The data showed 60-Hz cycles of the AC-voltage, AC-current, and DC-current. By inspecting the current through the transformer's leakage inductor, the multimode control variable mode operation can be demonstrated. Herein, for one of the two adjacent vectors (the one with a higher peak value), it remains in the same mode. For the other adjacent vector with lower peak values, the operation transits from mode 1 to mode 5 as the current pattern shifts from a triangular to a trapezoidal one. The Iₚ and Tₘ for both vectors, which stand for two UMC-cells, change accordingly to deliver a different amount of charge.

### Embodiments of UMC-Cell-Based Power Converter Isolated Topologies With Multimode Control

The previous section describes and demonstrates the implementation of the proposed multimode controller applied to a 3-phase DC-AC isolated topology. Here, the proposed controller allows for the precise control of two UMC-cells on a switching-cycle basis with the use of a robust set of offline computed lookup tables based on charge requirements, switching cycle duration, and input/output voltages. This control paradigm can be extended to multiple power converter existing and novel topologies using UMC-cell as building blocks with simple or four-quadrant semiconductor switches.

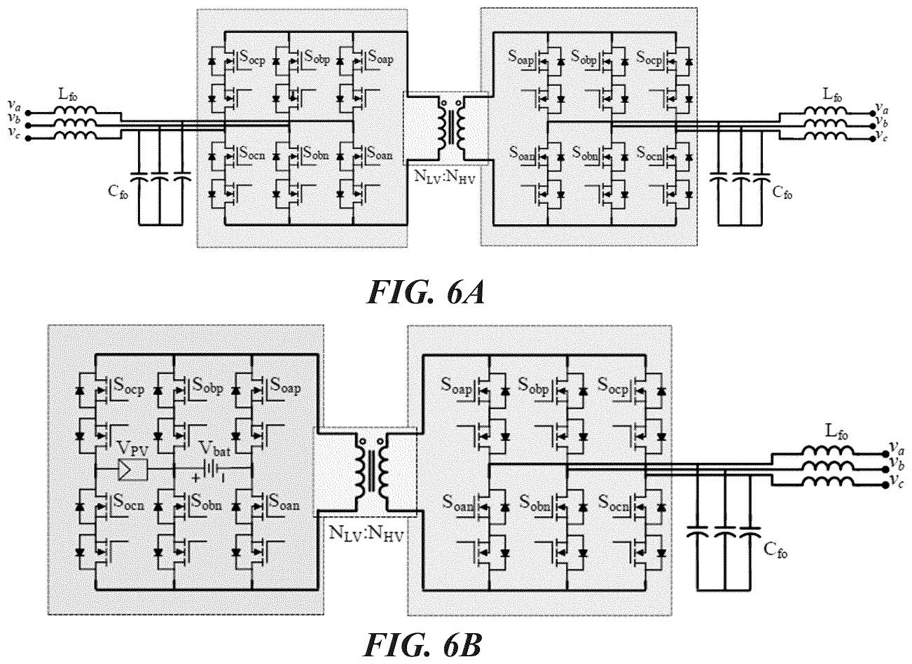

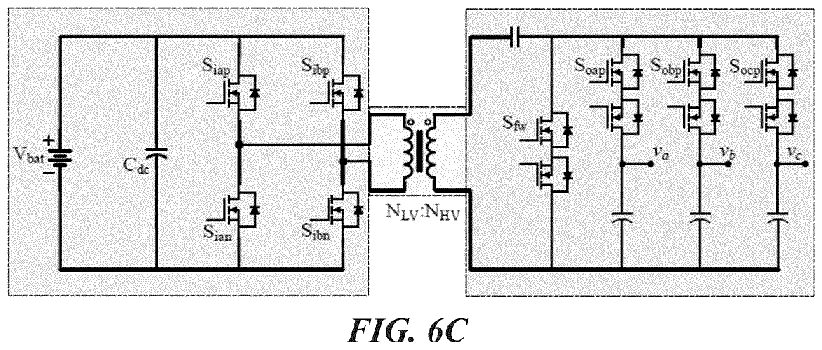

FIGS. 6A-6C depict several example embodiments of UMC-cell-based power converter isolated topologies that can be accurately controlled with the proposed controller. Such topologies extend to AC/AC 3-phase, multi-port DC-AC (3-phase), and DC-AC 3-phase microinverter. In all of these topologies, the four quadrant semiconductor switch branch can be realized with a single module with the proper semiconductor packaging techniques, which facilitates the thermal management of the devices at a similar footprint to a state-of-the-art voltage-source-converter (VSC).

Lastly, FIG. 6C illustrated a particularly novel UMC-cell-based DC-AC 3-phase microinverter. Herein, it is obvious to one skilled in the art that the input and output bridge topologies can be derived from the prior art. However, the implementation of the switching bran Sfw and, most importantly, the utilization of the proposed multimode control architecture to control such a topology constitutes a novelty.

### Discussion

Distributed energy resources (DERs), such as solar PV, EVs, energy storage, and green hydrogen, are seeing exponential growth across the world. In almost every case, the DER is manifested as a DC voltage/current, which needs to be interfaced with the grid. Typical power levels for such interconnections range from 200 watts to over 1000 kW per converter, often aggregated to reach more than 500 MW for some of the larger utility-scale systems. This requires a DC-to-AC converter that can transfer power from one or more DC ports to an AC port or vice versa as needed. The DC-to-AC power transfer capability is also required for a new emergent application of DC microgrids, which can be used to augment the existing AC grid. The need is extensible to a more generic power conversion requirement—i.e., from a given set of DC or AC ports to another set of DC or AC ports, with or without high-frequency isolation, and with minimal energy storage and smooth filtered waveforms. The basic operation of such converters can be understood with a simple DC-to-AC converter, and can be then extended to cover a multitude of operational scenarios.

This need is not new and has been met for decades using DC to AC inverters. With different voltages on the DC and AC sides, there has often been a need for a transformer, or for overrating of devices to manage variations. Further, in many applications, there is a need for galvanic isolation between the DC and AC sides—for safety or to avoid accelerated degradation for devices such as photovoltaic panels. This need has often been met with a DC/DC converter, such as the Dual Active Bridge (DAB) converter [1], with additional AC/DC and DC/AC converters on either side of the DAB converter. Multiple stages of conversion and the need for intermediate energy storage to decouple the three converters add to the cost and size of the converter and can limit the dynamic response. In such converters, it is desirable to realize the galvanic isolation with high-frequency transformers because that can dramatically reduce the size and cost of the system. On the other hand, this can lead to higher switching losses and can degrade the efficiency of the converter. Several converters have recently been proposed, such as the Soft Switching Solid State Transformer (S4T) [2], that realize high switching frequency and low losses through the use of soft switching techniques. However, for the S4T, the transformer and the ZVS resonant switch become limiting factors to its scalability. The current-source characteristics of the S4T also require reverse blocking switches, which are realized with Silicon IGBTs and Silicon Carbide diodes connected in series. While this results in higher conduction loss per device, this is more than offset by the reduced switching losses realized through zero voltage switching.

The advent of Silicon Carbide MOSFETs (SiC-MOSFET) has reduced the impact of tail-current associated turn-off loss for the IGBTs and leads to improved efficiency. SiC diodes also tend to have higher voltage drops and still cause higher conduction losses than desirable. Further, there is not much difference in SiC diode and SiC-MOSFET pricing, and a number of people have been looking at using two MOSFETs in series to realize the desired functionality. This can help to reduce conduction losses, especially at lower power levels (as compared to diode or IGBT). The resulting switch is clearly an AC switch, as it can conduct current and block voltage in both directions. AC switches have been known for a while, with new implementations such as the BidFET promising ever higher levels of performance [3]. The ability to use bidirectional switches in power converters also dates back 50+ years, with cycloconverters and matrix converters as early examples. The use of HF links with cycloconverters at a very high-power level also dates back to the 1970s [4]. Further, the possibility that HF links could be used to reduce transformer size was explored by many, including Ziogas, in the 1980s [5]. The idea of converting DC to AC with bidirectional power flows is not new, but we still see very few instances where this is applied today.

The S4T provides one approach, but a more common approach is as proposed by Kolar, where a DC side full-bridge converter and an AC side cycloconverter are controlled in the manner proposed for the DAB converter—using phase shift control to control power flows. The DAB converter has many desirable properties. It is a ‘minimal’ converter, with an input and output semiconductor bridge, a high-frequency transformer, and capacitive filters on DC and AC sides. The switching for the AC side converter also uses well-known space vector modulation techniques to select the device switching sequence.

This converter topology has been explored by several authors. However, the control approach has almost always relied on DAB-inspired phase shift control. While the use of phase shift control in the DC DAB converter is well known, its use in DC-AC systems bears further explanation. In this implementation, the DC bridge generates a square wave, while the three-phase AC bridge generates a space vector PWM-derived waveform, which is reversed in polarity over two half cycles to realize volt-second balance for the transformer winding. This approach uses averaging of two SVPWM vectors to synthesize the desired AC vector [6]. These two waveforms, each of which is periodic at the transformer switching frequency, are phase shifted as in the case of the DAB converter.

Similar to the DAB converter, the two bridge waveforms are impressed across the transformer leakage or series inductance, resulting in the transformer winding currents. These transformer winding currents are acted on by the switching functions of the DC and AC side bridges to realize DC and AC side control. The relationship between the phase shift and the input and output charge/power flows is very complex and depends on the specific operating point, including continuous and discontinuous conduction modes. No closed-loop predictable transfer characteristic can be derived, making this a difficult plant to control. This is particularly important on the AC side, where high bandwidth control is needed to realize stable operation in grid-connected multi-inverter systems.

Looking at the peak device stresses in the converter switches, we see another undesirable property. The DC/DC DAB converter has desirable switching properties with low peak current stresses, but only when it is operated with equal voltages on both sides of the transformer (on a 1:1 turns ratio referred basis). As the bridge voltages vary from the ideal case of equal voltages (as happens with AC voltages), the peak current stress increases dramatically, resulting in higher conduction and switching losses. In the case of the DC/AC system, the voltage varies widely over a cycle, resulting in high peak currents. Further, given sensing and control delays, it is very difficult to guarantee that the transformer does not get saturated—requiring the use of series capacitors on both windings. As a result of these challenges, even though the DAB structure is very attractive from a minimal component count perspective (often referred to as a minimal power converter), it has been challenging to realize an overall high-performance system that is practical and cost-effective.

### Experimental Results and Additional Examples

### Example #1 Multimode Control of HF Link Universal Minimal Converters

A first study was conducted to develop a UMC that can be used to realize AC/AC, DC/AC, AC/DC, and DC/DC conversions and control scheme that can employ self-contained, and repetitive power transfer cycle using a generic unit cell. Over each cycle, the UMC-unit cell delivers a controlled amount of charge with net zero DC flux, with a specific set of terminal voltages and mode. This eliminates the transformer saturation related issues. Further, the presented mode selection strategy ensures lowest peak current value through the transformer leading to reduced stress on the overall system. Compared with other control and operating schemes, it allows the converter to operate at a wide range of voltage conversion ratio,

$$\frac{{v}_{o}}{{v}_{s}} ,$$

while realizing optimization of parameters such as the device stress. It also allows simple implementation as the mode-selection strategy and control parameters can be pre-calculated and stored in LUTs. The example control realizes a current-source converter, which excludes bulky DC-link capacitors, has better current fault behavior, utilizes capacitive filter, and inherently reduces common-mode EMI.

The first study conducted simulations and validated the simulations using hardware prototype. Preliminary results showed the unit cell can achieve the desired charge transfer while shifting modes across a wide range of voltage transfer ratios to realize the example UMC multimode control functionality. Example #2, herein extends the concept from DC/DC conversion to a universal multiphase AC universal minimal converter with bidirectional power flow. The analysis and additional modulation strategy to achieve three-phase AC operation are also further described in example #2, herein.

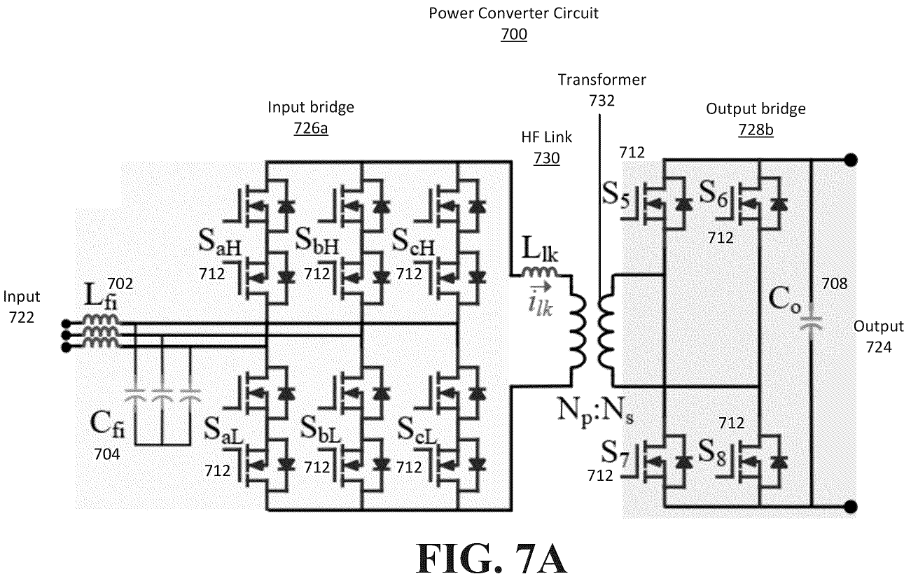

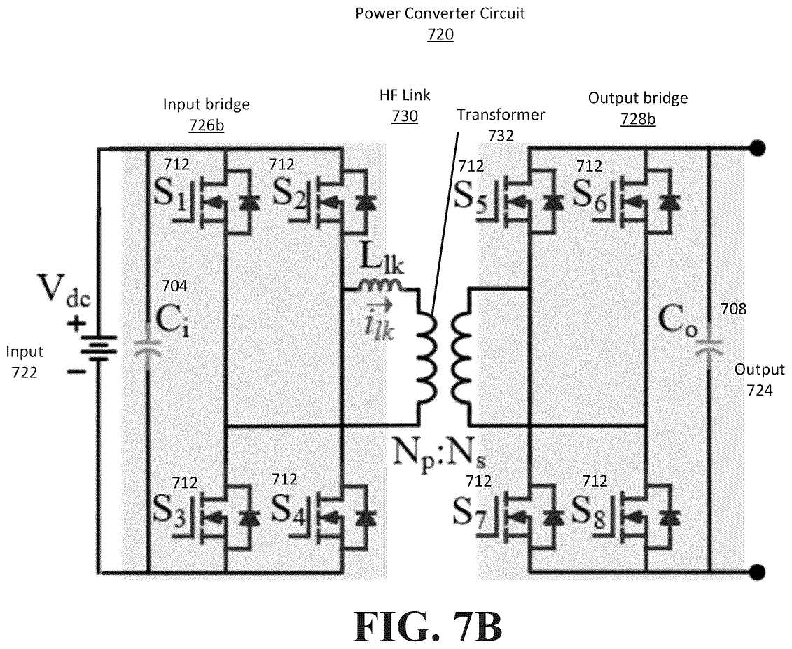

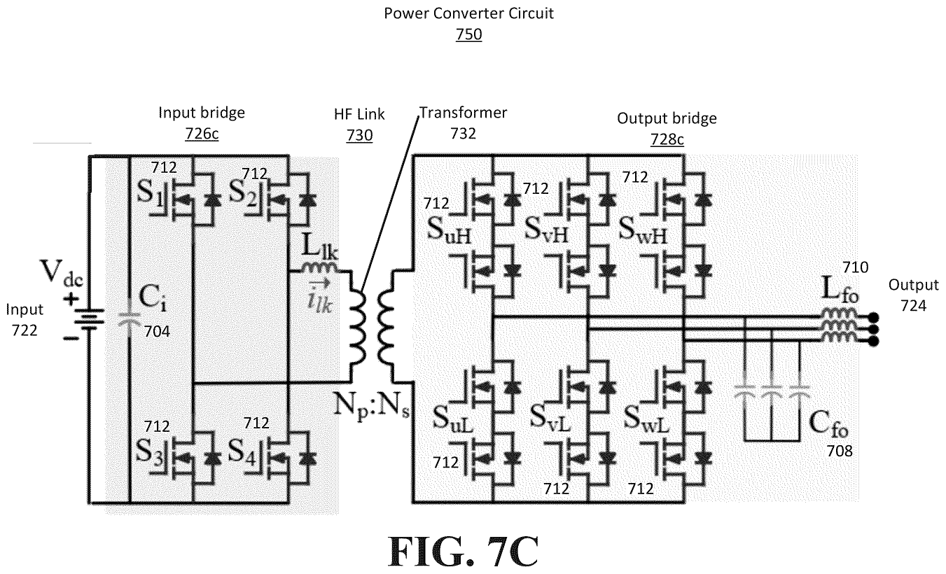

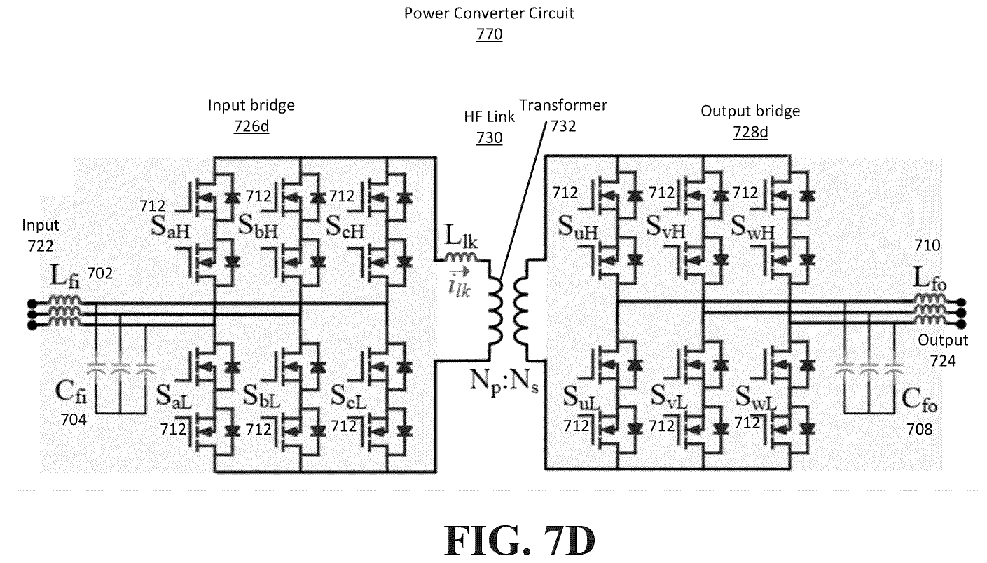

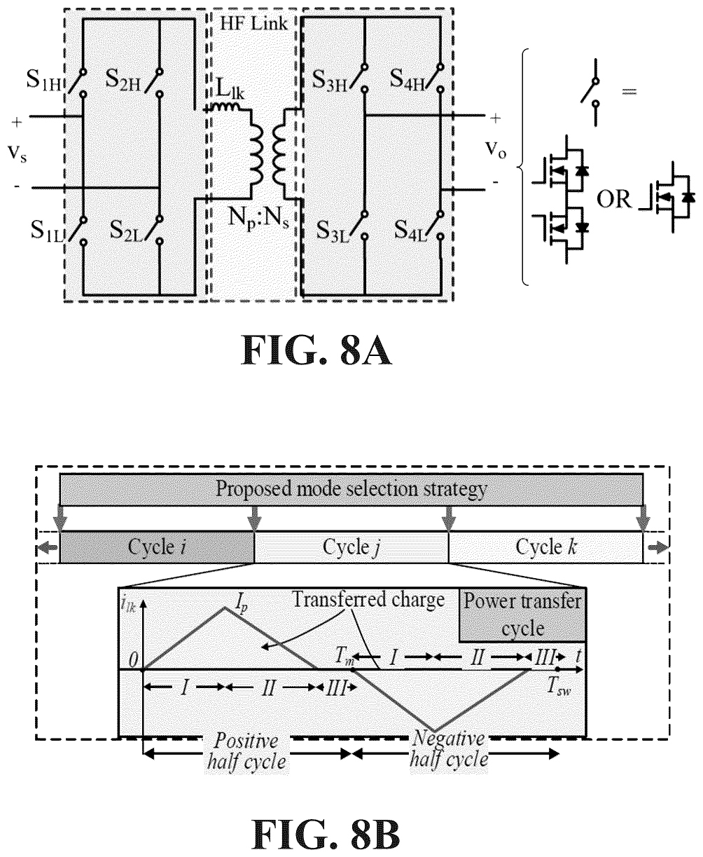

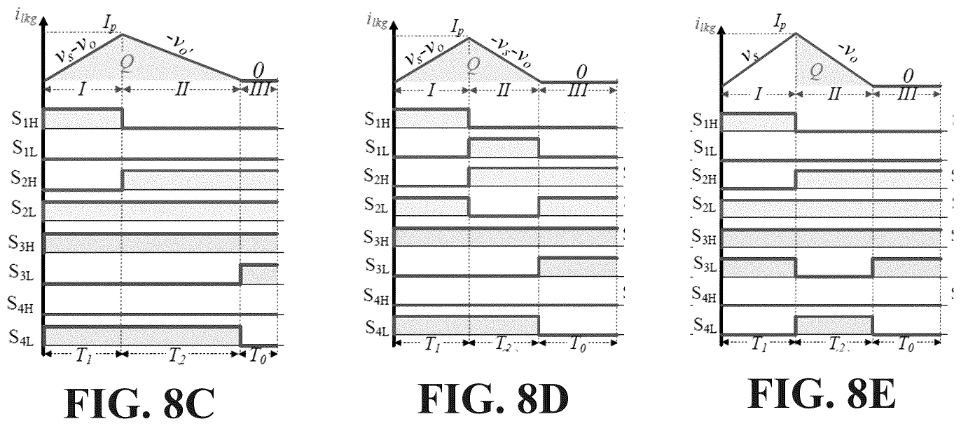

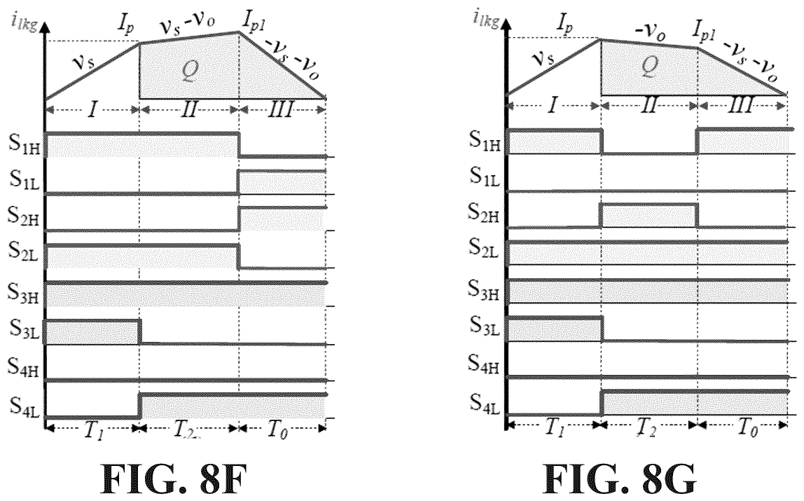

Example Circuit Architecture. To generalize the control and operation of the example UMC family of circuits described herein, a UMC-unit cell is disclosed and illustrated in FIGS. 2A, 2B, and 5A. An example energy transfer cycle for the UMC-unit cell is shown in FIG. 8B. The UMCs from FIGS. 7A-7D can be operated by transferring an energy packet from the input port to the output port over each switching cycle through the HF link transformer. Further, it is also important to ensure that the transformer does not saturate in the example embodiment. For example, in FIGS. 7A-7D all ports feature capacitive filters, which can ensure that the voltage over the switching cycle remains constant. As a result, over a switching period, the system can be reduced to a UMC-unit cell from FIG. 8A with a desired level of energy transfer. This concept is utilized to achieve a universal and simpler control of the UMCs.

FIG. 7A illustrates a power converter circuit 700 for three-phase AC to DC conversion according to embodiments of the present disclosure. The power converter circuit 700 includes an HF link 730 and transformer 732. An input bridge 726a, shown in FIG. 7A is configured for a 3-phase input, and includes 6 switches 712. The output bridge 728a is configured for a DC output, and includes four switches. Optionally, the power converter circuit 700 can further include input inductors 702 and input capacitance 704. Alternatively or additionally, the power converter circuit 700 further includes an output capacitance 708.

FIG. 7B illustrates a power converter circuit 720 for DC-DC conversion according to embodiments of the present disclosure. The power converter circuit 720 includes an HF link 730 and transformer 732. The input bridge 726b shown in FIG. 7B is configured for a DC input, and includes four switches 712 and an input capacitance 704. The output bridge 728b is configured for a DC output and includes four switches 712 and an output capacitance 708.

FIG. 7C illustrates a power converter circuit 750 for DC-DC conversion according to embodiments of the present disclosure. The power converter circuit 750 includes an HF link 730 and transformer 732. The input bridge 726c shown in FIG. 7C is configured for a DC input and includes four switches 712 and an input capacitance 704. The output bridge 728c is configured for a three-phase output and includes six switches 712, an output capacitance 708 and an output inductance 710.

FIG. 7D illustrates a power converter circuit 770 for AC-AC conversion, according to embodiments of the present disclosure. The power converter circuit 770 includes an HF link 730 and transformer 732. The input bridge 726d shown in FIG. 7D is configured for a three-phase input, and includes six switches 712, an input inductance 702, and an input capacitance 704. The output bridge 728d is configured for a three-phase output and includes six switches 712, an output capacitance 708, and an output inductance 710.

It should be understood that the power converter circuits 700, 720, 750, 770 shown in FIGS. 7A-7D are intended only as non-limiting examples of converter circuit topologies that can be used in embodiments of the present disclosure. Additional non-limiting examples of circuit topologies are described with reference to Example 1 and Example 2 herein.

FIG. 8B illustrates an example a repetitive ‘power transfer cycle’ realized for the UMC-unit cell from FIG. 8A. In FIG. 8B, each positive switching cycle is followed by an identical negative cycle to transfer equal amount of energy/charge, but with opposite current polarities ensuring that the transformer does not saturate. Further, for a given energy packet to be transferred, multiple switch commutation patterns can be realized as shown in FIGS. 8C-8G. These example commutation patterns are referred to herein as ‘Modes.’ The five modes (1 to 5) from FIGS. 8C-8G represent the multiple possible ways to deliver the desired charge from one port to other. The example embodiment uses a multimode control strategy that chooses an ‘optimal’ operating mode for every switching cycle, with dramatic impact on converter stresses and losses. The UMC-unit cell (FIG. 8A), with proper switching, can thus transfer a specific amount of energy/charge from one port to another port using the example scheme as described herein.

Example Multimode Control. Among various possible modes of UMC-unit cell, five most practical modes are identified to achieve the desired charge transfer over a wide range of input (vₛ) and output (vₒ) voltages. The positive half of the power transfer cycles (from FIG. 8A) of mode-1 to 5 are shown in FIGS. 8C-8G, respectively, with the corresponding status of UMC-unit cell switches. It can be seen from FIGS. 8C-8G that, depending on the switching states, different voltages are applied across the leakage inductor (Lₗₖ) during the sub-intervals I-III for the duration of T₁, T₂ and T₀, respectively. This results in differences in UMC operating characteristics such as peak current (Iₚ) through Lₗₖ. To further study this difference among the operating modes, the associated Iₚ value for each given mode can be obtained. For the operation of UMC-unit cell in mode 1 (FIG. 8C) the desired charge to deliver per energy transfer cycle, ΔQ, can be expressed as the area under the i_{lkg} curve as in Equation 1.

$$Δ {Q}_{mode 1} = 0.5 * {I}_{p} * ( {T}_{1} + {T}_{2} ) = {I}_{o} * {T}_{m} \qquad ( Eq . 1 )$$

In Equation 1, Iₒ and Tₘ represent desired output current and duration of half cycle, respectively. Further, the T₁ and T₂ can be obtained using the volt-sec balance across Lₗₖ as expressed in Equation 2.

$${T}_{1 , mode 1} + {T}_{2 , mode 1} = \frac{{I}_{p} {L}_{lk}}{{v}_{s} - {v}_{o}} + \frac{{I}_{p} {L}_{lk}}{{v}_{o}} \qquad ( Eq . 2 )$$

Now, using (1) and (2), Iₚ can be expressed as in (3).

$${I}_{p , mode 1} = \sqrt{\frac{2 {I}_{o} {v}_{s} {T}_{m}}{{L}_{lk}} [ \frac{{v}_{o}}{{v}_{s}} - {( \frac{{v}_{o}}{{v}_{s}} )}^{2} ]} \qquad \# ( 3 )$$

It can be seen from (3) that Iₚ is a function of Iₒ, vₛ and vₒ. In a similar manner, the Iₚ values can be obtained for the remaining modes. First, the delivered charge per energy transfer cycle for modes 2-5 can be expressed as in Equations 4-6, respectively.

$$Δ {Q}_{mode 2} = \frac{1}{2} * {I}_{p} * ( {T}_{1} + {T}_{2} ) \qquad ( Eq . 4 )$$

$$Δ {Q}_{mode 3} = \frac{1}{2} * {I}_{p} * {T}_{2} \qquad ( Eq . 5 )$$

$$Δ {Q}_{mode 4 or 5} = \frac{1}{2} * {I}_{p} * ( {T}_{0} + 2 * {T}_{2} ) \qquad ( Eq . 6 )$$

Consequently, Iₚ for mode 2-5 can be derived similarly, as shown in Equations 7-10, respectively.

$${I}_{p , mode 2} = \sqrt{\frac{{I}_{o} {v}_{s} {T}_{m}}{{L}_{lk}} [ 1 - {( \frac{{v}_{o}}{{v}_{s}} )}^{2} ]} \qquad ( Eq . 7 )$$

$${I}_{p , mode 3} = \sqrt{\frac{2 {I}_{o} {v}_{o} {T}_{m}}{{L}_{lk}}} \qquad ( Eq . 8 )$$

$${I}_{p , mode 4} = \frac{1}{2} [ \frac{2 {I}_{o} {T}_{m}}{{T}_{1} + {T}_{2}} - ( {T}_{1} + {T}_{2} ) \frac{{v}_{s} - {v}_{o}}{{L}_{lk}} ] \qquad ( Eq . 9 )$$

$${I}_{p , mode 5} = \frac{1}{2} [ \frac{2 {I}_{o} {T}_{m}}{{T}_{1} + {T}_{2}} + ( {T}_{1} + {T}_{2} ) * \frac{{v}_{o}}{{L}_{lk}} ] \qquad ( Eq . 10 )$$

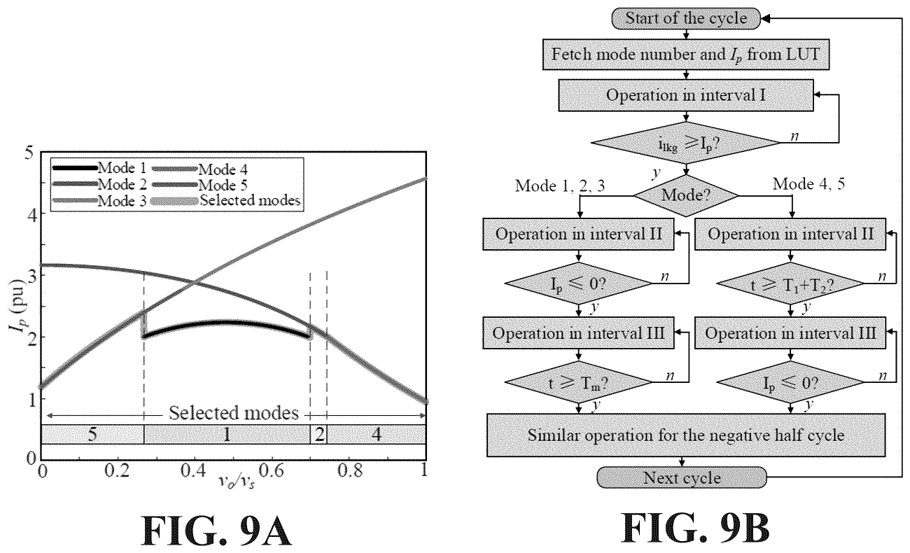

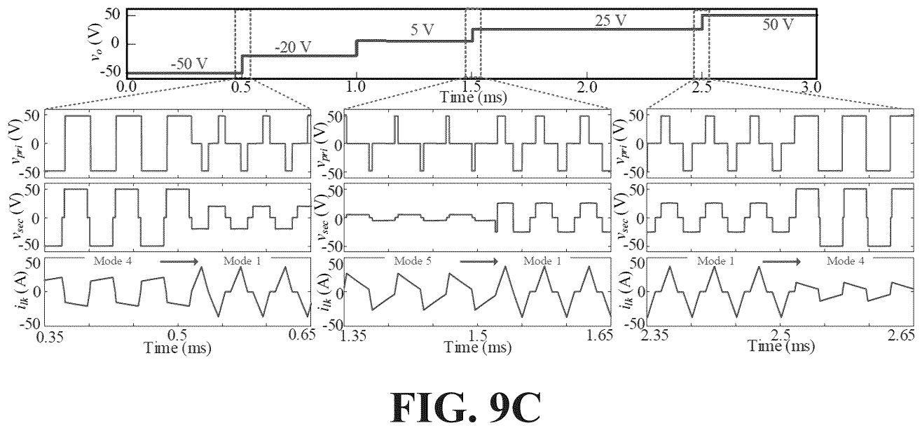

To observe the trend of Iₚ values for different modes, the obtained values of Iₚ for all modes using Equations 3, 7-10 are plotted in FIG. 9A with the variation of voltage conversion ratio vₒvₛ from 0 to 1. As seen from FIG. 9A, each mode results in a different Iₚ values for given

$$\frac{{v}_{d}}{{v}_{s}}$$

with a same delivered ≢Q per cycle. It can thus be seen from FIG. 9A that different modes yield very different Iₚ profile over the plotted

$$\frac{{v}_{o}}{{v}_{s}}$$

range. Consequently, an optimization strategy can be adopted to minimize the Iₚ or other performance parameters across the operating range of

$$\frac{{v}_{o}}{{v}_{s}} .$$

In the example control scheme, the most optimal mode is selected to achieve the lowest Iₚ value for desired Q and the sending and receiving port voltages. The expressions for other performance parameters such as the rms current can be also derived using Equations 1, 2, 4-6. Consequently, similar analysis can also be carried out for other optimizations such as minimization of converter device losses. Since the calculations in Equations 1-10 can be performed offline, the optimal mode selection result can be stored and accessed from the controller's memory during real-time operation. This drastically reduces the controller burden and turn the multimode control that utilizes the optimal mode selection strategy into a simple and practical approach.

For each energy transfer cycle, embodiments of the present disclosure can select an optimal mode can be selected to achieve desired optimization objectives while maintaining the simplicity of the control structure. To realize the control of UMC based on the mode selection strategies described herein, two control parameters as Iₚ and Tₘ are used in the present example. Tₘ defines total duration of the energy transfer cycle in each mode and can be expressed as in Equation 11.

$${T}_{m} = {T}_{1} + {T}_{2} + {T}_{0} \qquad ( Eq . 11 )$$

The lowest value of Tₘ can be restricted at certain value that defines the maximum allowable switching frequency (fₘₐₓ). For example, for operation in mode-1, the minimum value of Tₘ(T_{m,min}) can be expressed as in Equation 12.

$${T}_{m , min} = \frac{1}{{f}_{max}} = {T}_{1} + {T}_{2} = \frac{2 {V}_{s} {L}_{lk} {I}_{o}}{{V}_{o} * ( {V}_{s} - {V}_{o} )} \qquad ( Eq . 12 )$$

The leakage inductance can be selected in such a way that proper switching frequencies can be selected to enable most of the operating modes.

The selected mode and the corresponding pre-calculated Iₚ can be stored in a look up table (LUT) that is computed offline based on voltage transfer ratios and the needed ΔQ. This provides a high-bandwidth and simple control implementation for embodiments of the control scheme. Further, the controller decides the switching times in real-time based on the look-up table, thus enabling higher controller bandwidth. The overall operation of power transfer cycle repeats itself achieving the transfer of desired Q between the UMC ports, while the use of identical positive and negative half cycles eliminates the issue of transformer saturation. For the optimized Iₚ trajectory of the selected modes shown in FIG. 9A, it is seen that for the desired

$$\frac{{v}_{o}}{{v}_{S}} ,$$

a particular mode gives the lowest Iₚ and is selected. This leads to significant reduction in peak current stress. For low and high values of

$$\frac{{v}_{o}}{{v}_{s}} ,$$

which would be important for AC operation, the example control scheme achieves significant improvement in Iₚ values. For example, in FIG. 9A, when

$$\frac{{v}_{o}}{{v}_{s}}$$

is at 0.9, the optimized UMC Iₚ value (with mode 4) is observed to be only 25% compared to the unoptimized case (with mode 3). In this manner, a generalized and robust control can be achieved irrespective of the DC or AC ports.

A flowchart for an example embodiment of a control scheme over the positive half is depicted in FIG. 9B. Initially, Iₚ and mode values are selected from the offline computed look up table, for the desired Q. For example, for the operation in mode 1, during sub-interval I (FIG. 8C), voltage vₛ-vₒ is applied across Lₗₖ. For simplicity, the depicted voltages are scaled for the turns ratio of 1:1. Once iₗₖ reaches Iₚ, interval II operation is realized as per FIG. 8C, leading to the application of −vₒ across Lₗₖ. This interval continues till iₗₖ reaches zero and finally zero voltage is applied in interval III. Once the positive half cycle ends, the negative half cycle can be realized in an inverted manner.

Such operation can ensure net zero residual DC flux to avoid saturation in the transformer. In this way, the power transfer cycle repeats itself with updated mode and Iₚ, and thus optimizes the performance on a switching-cycle basis. Moreover, as the operation is achieved for a unit cell, it is applicable for all UMCs shown in FIGS. 7A-7D.

Table 1 shows example parameters employed in the simulation.

TABLE 1

| Parameter | Value | Parameter | Value |
|---|---|---|---|
| Vₛ | 48 V(24 V)* | L_{kg} | 6 μH(22 μH)* |
| Vₒ | −50 to 50 V(24 V_{ac})* | Nₚ:Nₛ | 1:1 |
| C_{dc} | 100 μF(35 μF)* | F_{sw} | 11 kHz(36 kHz)* |
| Iₒ | 20 A(2 A)* | P_{rated} | 1 kW(2 kW)* |

*Used for experimental validation

Such operation can also be used to realize a DC-AC inverter with AC modulation strategy. If terminal voltages at the input and output ports are provided, the multimode control scheme can select a feasible and optimal mode that can achieve the desired charge transfer. In case of multi-phase AC, the multi-phase voltages can be mapped to vₒ with traditional AC modulations such as spacevector-modulation (SVM). Further illustration, analysis, and implementation can be found in example 2, herein.

Simulation Results. To demonstrate the efficacy of embodiments of the multimode control scheme described herein, the UMC operation with a constant input voltage and variable output voltage was considered for simulation studies. An example scheme was implemented on the considered UMC under PLECS environment, for the parameters as per Table I. Further, the output voltage (v₀) of the UMC was varied over wide range (−V_{o,rated} to +V_{o,rated}). The obtained results are shown in FIG. 9C. These results show the waveforms for vₒ, primary and secondary side voltages vₚᵣᵢ and v_{sec}, and iₗₖ. As can be seen from FIG. 9C, the UMC-unit cell can operate in a preselected mode with optimal value of Iₚ. Further, the bidirectional output voltage is obtained without changing the control approach.

FIG. 9C also shows that over each switching cycle a suitable mode is selected and applied depending on the converter operating conditions and for minimum Iₚ. Further, the power transfer cycle is repeated with zero current at the start and end of the cycle each time. This leads to mitigation of the transformer saturation related issues eliminating the need for the series decoupling capacitors. In this way, the overall functionality of UMC can be achieved with a simple and robust manner.

Hardware Validation. To validate the performance of example multimode control scheme for the UMC-unit cell, an experimental prototype rated at 2 KW was constructed for the DC/AC UMC. FIG. 9C depicts the complete hardware setup with both bridges and a leakage inductor. An inductor was used to connect two bridges of the UMC prototype. Further, for the demonstration purpose, two bridges are directly coupled with only leakage inductor achieving non-isolated power transfer. Nonetheless, the results can be extended for the isolated stages with suitable turns ratio. Further, in the present disclosure, the AC-side bridge is controlled to obtain unidirectional DC voltage. Nonetheless, this setup can also be used for DC to AC conversion, whose details are presented in the second example herein [18]. The detailed parameters of the constructed hardware prototype can be found in Table I.

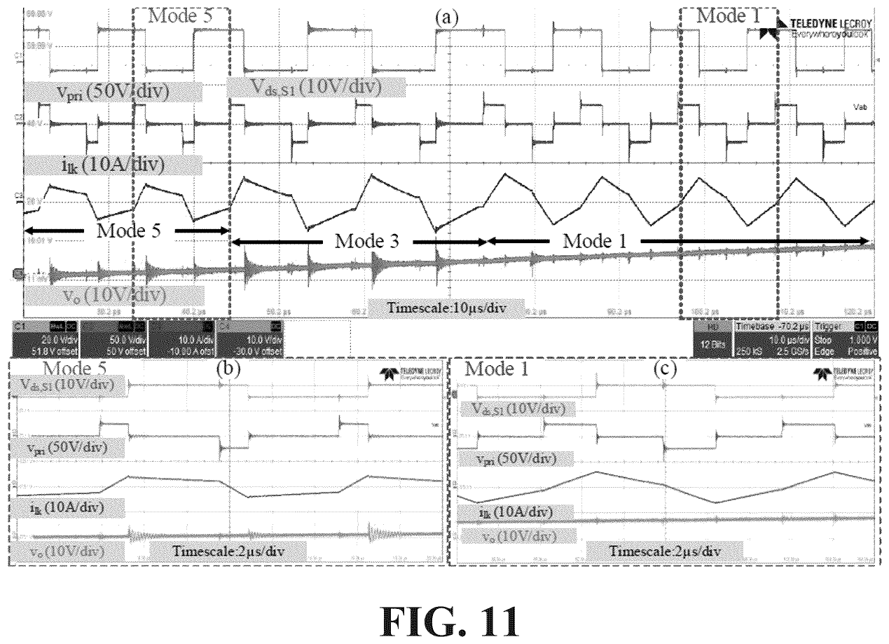

The developed prototype was tested for the multimode operation of the UMC-unit cell. For this, the DC-side bridge is excited with a constant voltage source of 24 V, while the output of AC bridge is connected to the resistive load of 22Ω. With the application of several modes the output voltage can be gradually increased from 0 to a desired value. The obtained results for this operation are shown in FIG. 11, where the waveforms of the voltages at two sides of the inductor, leakage inductor current, and the output voltages are depicted. In FIG. 11, the UMC-unit cell operates in three different modes (mode 5-mode 3-mode 1) in sequence. Further, it smoothly transits from one mode to other. It can also be observed that each mode imposes different values of Iₚ through Lₗₖ. Therefore, by selecting a most suitable mode, the performance of the UMC can be improved.

Discussion. The multimode control scheme described herein can optionally be implemented using a family of single-stage high-frequency-link bidirectional converters with DC or AC ports. These configurations represent a family of universal-minimal-converters (UMC), which can be reduced to a generic unit cell over each switching cycle using the example multimode control scheme. This universal and simpler control can integrate parasitics while achieving lower device stresses than other schemes. Embodiments of the present disclosure can further include a mode selection strategy used to optimize the performance of considered UMC-unit cell over each switching cycle. Further, each cycle starts and ends with zero current to reduce energy storage and manage transformer saturation. Detailed derivation of the UMC-unit cell operating characteristics using the example control scheme is presented, along with simulation results to verify the operation. A hardware prototype of UMC was built and tested to validate the multi-mode operation of the example UMC-unit cell. DC to multiphase AC operation realization are further shown in Example 2, herein.

The modern electric grid can include high penetration of distributed energy resources (DERs) such as solar panels (PV), electric vehicles (EV), energy storage, and green hydrogen [1′]. The integration of such resources, often manifested as DC resources, with the AC grid can include power sharing between AC and DC ports in both directions [2′]. Also, in many scenarios, such interfaces requires a galvanic isolation stage to satisfy safety standards [3′]. Such requirements can be met with an isolated converter that can deliver the desired amount of charge from one DC or AC port to another DC or AC port. Further, additional requirements may include bi-directional power flow capability, minimal intermediate energy storage, as well as a simple and low-cost control approach [4′].

High-frequency (HF) link-based converters including dual active bridge (DAB) stages can address some of these needs [5′]-[7′]. Depending on the desired interface to the DER, such configurations often utilize AC/DC and DC/AC stages on either side [8′]-[10′]. In similar manner, such multi-stage interfaces are utilized for various DERs [9′]. However, one of the limitations of such configurations is their poor efficiency due to the multistage architecture with the need for intermediate energy storage. Further, the multi-stage structure leads to higher cost and size of the system with poor dynamic performance.

The single-stage HF-link cycloconverter can be a potential candidate for the afore-mentioned systems [11′]. However, it can involve complex control, and offers high values of conduction and switching losses. Device losses can be lowered with soft switching in the single-stage soft switching solid state transformer (S4T) configurations [12′]. These S4T converters utilize current source behavior featuring low EMI, short-circuit fault behavior [13′], [14′]. However, S4Ts require ZVS resonant switches, which limits their scalability for the considered DER systems. A single-stage DAB-based approaches as shown in FIG. 7A can be considered as the minimal conversion interfaces for the afore-mentioned systems [15′], [16′]. However, these single-stage converters can involve phase-shift-based control law including complex relationships between the phase shift and desired power imposing implementation challenges. This becomes even more challenging for the scenarios with AC interface and wide variation of voltage values, where high bandwidth control is needed to realize stable operation in grid-connected multi-inverter systems [17′]. Further, given sensing and control delays, it is very difficult to guarantee that the transformer does not get saturated, requiring the use of series capacitors on both windings [15′]. As a result of these challenges, even though the DAB structure can be attractive from a minimal component count perspective (referred to herein as a universal minimal converter), it is challenging to realize an overall highperformance system that is practical and cost-effective. Consequently, a universal and practical control approach for the minimal topology, as demonstrated in example embodiments of the present disclosure, can implement a variety of different power conversion functions that improve systems and methods for power conversion.

Embodiments of the present disclosure include multimode control schemes for the family of universal minimal converters (UMCs), which can be generalized to realize AC/AC, DC/AC, AC/DC, and DC/DC conversions. The example control scheme can exploit the minimal DAB-like topology, and realizes an isolated, bi-directional single-stage current source converter to achieve energy transfer between two ports, which can be either DC or AC. Compared with other control and operating schemes, the example embodiment can achieve the following benefits: (A) The multimode control allows the converter to operate at a wide range of voltage conversion ratio, while realizing optimization for operating characteristics such as the device current stress. (B) Such control schemes can allow for simple implementation, as the mode-selection strategy and control parameters can be calculated offline. (C) It can enable minimal energy storage as the transformer current starts and ends at zero for each energy transfer cycle, and each cycle is decoupled from previous or subsequent ones.

The operating principles of the UMC-unit cell can be used for different types of power conversions, such as DC/AC, for example with an AC modulation strategy. The current-source source structure of the example embodiment can also be implemented without bulky DC-link capacitors, requires only capacitive filters, retains better fault current behavior, and can inherently reduce common-mode EMI.

### Example 2—Multiphase AC Systems

The study (referred to herein as the second study) additionally developed the control and operation for DC and polyphase systems and evaluated the control and operation for the DC/AC realization of UMC. The second study showed that DC/AC conversion can be achieved with the same principles for UMC unit cell coupled with AC modulation. Simulations were performed in the second study to validate the operation of high-performance DC/AC converters with a wide operating range, and highlight the reduced device peak currents and stress compared with traditional implementations of such converters. A hardware prototype was built and tested to validate the functionality of the example control scheme and operation.

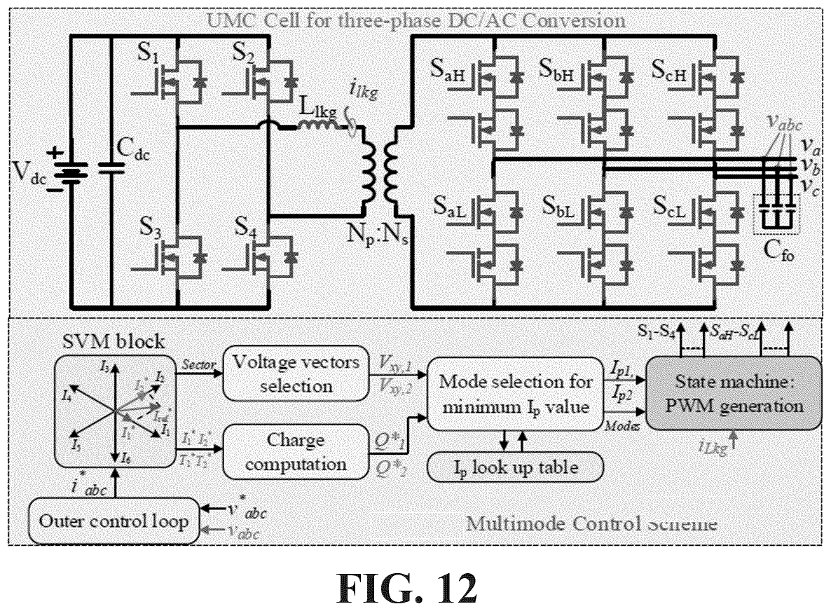

Example System Architecture. An example embodiment of the present disclosure including a HF-link three-phase DC/AC realization of UMC was studied using the multimode control schemes described herein. The overall architecture of the example system is shown in FIG. 12. In FIG. 12 the circuit schematic represents a universal minimal converter (UMC) unit cell for three-phase DC/AC conversion, where bidirectional switches are used on the AC-bridge to achieve four-quadrant operation. The UMC is controlled using the example multimode control scheme shown in FIG. 12. The example control scheme utilizes the current reference from outer control loop as shown in FIG. 12, to specify the current or charge Q that is required. Further, using the principle of space vector modulation, the desired charge values and line voltage information were obtained for the given switching cycle. Finally, an example mode selection block is utilized to generate optimal parameters for the PWM generation.

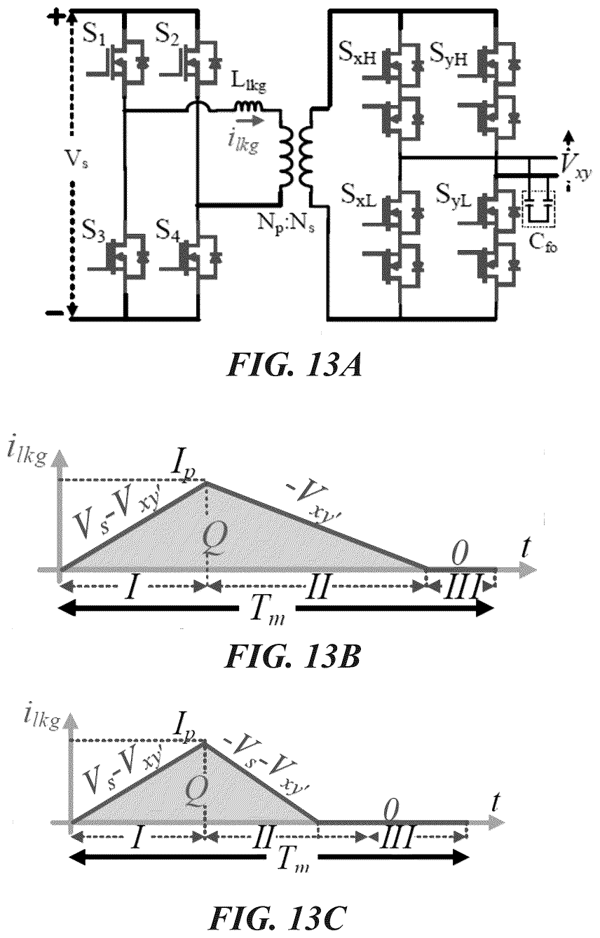

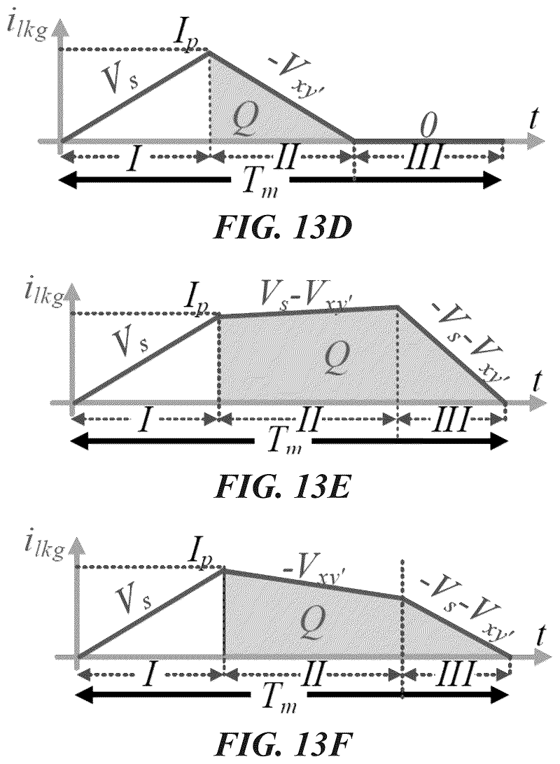

Example Control System. As illustrated in Example 1, herein, the considered DC/AC UMC can be reduced to a fundamental unit cell as shown in FIG. 13A. The example control scheme reduces the operation of considered DC/AC configuration to a simple ‘power transfer cycle,’ which represents a repetitive switching cycle to deliver a desired amount of charge between the DC and AC sides. The secondary side of the unit cell from FIG. 13A realizes the required line voltage (V_{xy}) for the given cycle. In each control cycle, the required V_{xy} can be selected using the vector mapping table as per an example vector mapping table.

Table 1A shows a vector mapping to a UMC-unit cell.

TABLE IA

| Space | Equivalent | Equivalent | | | | |
|---|---|---|---|---|---|---|
| Vector | V_{xy} | I_{xy} | S_{xH} | S_{xL} | S_{yH} | S_{yL} |
| I₁ | V_{ab} | i_{ab} | S_{aH} | S_{aL} | S_{bH} | S_{bL} |
| I₂ | V_{ac} | i_{ac} | S_{aH} | S_{aL} | S_{cH} | S_{cL} |
| I₃ | V_{bc} | i_{bc} | S_{bH} | S_{bL} | S_{cH} | S_{cL} |
| I₄ | V_{ba} | i_{ba} | S_{bH} | S_{bL} | S_{aH} | S_{aL} |
| I₅ | V_{ca} | i_{ca} | S_{cH} | S_{cL} | S_{aH} | S_{aL} |
| I₆ | V_{cb} | i_{cb} | S_{cH} | S_{cL} | S_{bH} | S_{bL} |

The vector mapping table can list the switching states for various current space vectors which can be generated using the AC stage. This suggest that the AC stage operates as a current source inverter (CSI). Further, Table IA also maps the switching states of UMC switches on three AC legs (S_{aH}, S_{aL}, S_{bH}, S_{bL}, S_{cH}, and S_{CL}) to that of unit cell (S_{xH}, S_{xL}, S_{yH}, and S_{yL}) from FIG. 13A. This information can be utilized in the example control scheme as discussed herein. With this approach, the same operating principles discussed in Example 1 can be used to achieve the desired DC to three-phase AC conversion.

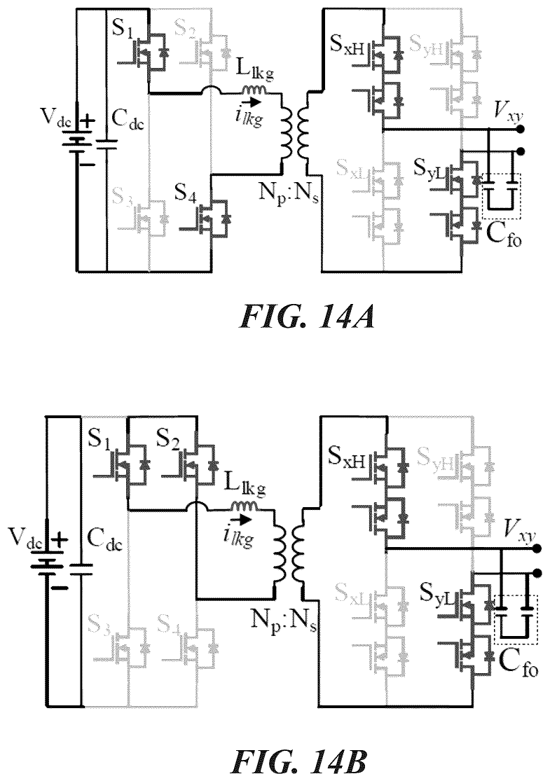

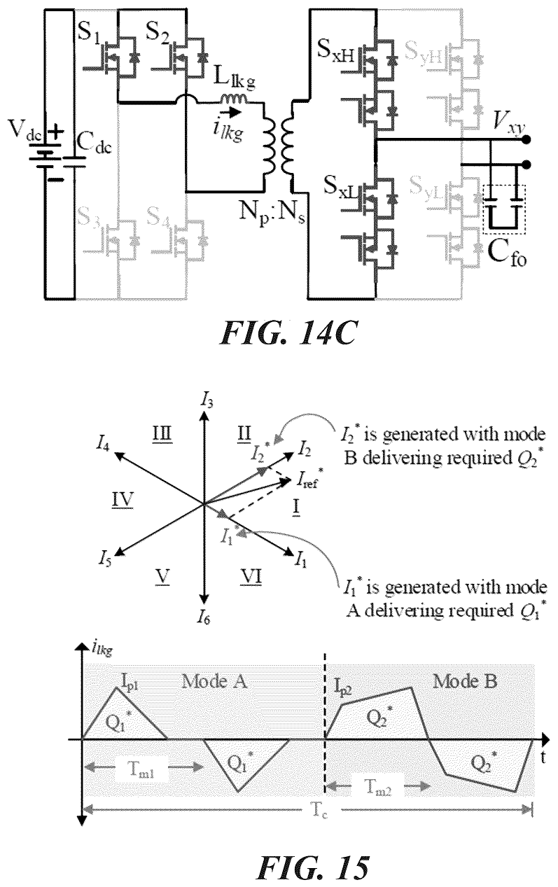

Once the DC/AC UMC is reduced to a UMC-unit cell, the UMC operation with the example multimode control structure was studied in more detail. As described in Example 1, five different operating modes can be used to achieve the desired charge transfer. These five modes are also shown in FIGS. 13B-13F. In each mode there can be three sub-intervals (I-III), where the UMC operates with different switching states. For example, the equivalent circuits of the UMC-unit cell for the operation over the positive half cycle, with mode 1, are shown in FIGS. 14A-14C. As can be seen from FIGS. 14A-14C, the equivalent circuits illustrate the operation in intervals I, II, and III, respectively as per FIG. 13B. As can also be seen from FIG. 14A, during interval I, S₁, S₄, S_{xH} and S_{yL} are turned-on. This applies a voltage of Vₛ-V′_{xy} across the leakage inductor (L_{lkg}), where V′_{xy} indicates the selected line-to-line voltage referred to the primary side. This increases the current through L_{lkg} (i_{lkg}). Once the required Iₚ value is reached, S₁, S₃, S_{xH} and S_{yL} are turned-on to realize interval II as per FIG. 13B and FIG. 14B. This results in application of −V′_{xy} across L_{lkg}, resulting in reduction of i_{lkg} to zero. The remaining duration is dedicated to the interval III, where null states are utilized to apply zero voltage across L_{lkg} as per FIG. 13B and FIG. 14C. At the end of the positive half cycle, the negative halfcycle starts. The negative half cycle is kept essentially similar to the positive one with reversed polarity of i_{lkg} avoiding the saturation of the transformer. The charge delivered to the output port is the area under the curve, which equals the desired Q. A next power transfer cycle can then be initiated with the updated mode selection to provide the per-cycle optimized performance. This concept coupled with a suitable modulation strategy can be utilized to achieve the DC-AC operation with desired performance improvement. In the example embodiment described herein, a space vector modulation approach is utilized to generate the reference charge values for the three-phase DC-AC operation of the UMC using the example multimode control scheme as illustrated in FIG. 12.

In the example control scheme, the SVM can be used to generate the reference current vectors, which are then translated to the reference charge values for the implementation of the multimode control scheme. The overall control structure of this implementation is illustrated in FIG. 12. The study included an exemplary case with the reference vector locating in first sector of the space vector diagram is explained. FIG. 15 illustrates the space vector diagram of the three-phase AC bridge, which essentially operated as a current source inverter (CSI) in the considered UMC, for the given instant in sector I with reference current of I_{ref}*. This reference is essentially projected along two adjacent vectors as I₁* and I₂* (FIG. 12), which can be calculated using θ, the angle of I*_{ref}, as expressed in Equation 1′ and Equation 2′, respectively

$${I}_{1}^{*} = {I}_{ref}^{*} \cdot sin θ \qquad ( Eq . {1}^{′} )$$

$${I}_{1}^{*} = {I}_{ref}^{*} \cdot sin ( 60 ° - θ ) \qquad ( Eq . {2}^{′} )$$

Each of these vectors can be realized using the example multimode control scheme with dedicated power transfer cycle with the computed charge references Q₁* and Q₂* for I₁* and I₂*, respectively as also shown in FIG. 15. The amount of charge to be delivered is determined by the length of the projected vector, and the output voltage as can also be seen in FIG. 12. The relationship between the charge and current can be derived using the time duration of the energy transfer cycle, Tₘ, or using the peak current Iₚ and any of the time intervals, T_{I}, T_{II} and T_{III}. For example, the expression for mode I can be expressed as in Equation 3′ [16].

$${Q}_{1 , mode 1}^{*} = {T}_{m} \cdot {I}_{1}^{*} = \frac{1}{2} {I}_{p} \cdot ( {T}_{1} + {T}_{2} ) \qquad ( Eq . {3}^{′} )$$

Complete set of derivations and resulting expressions are described with reference to Example 1 herein. The reference vector realization can be implemented for other sectors. As the reference vector rotates and changes sectors, the UMC-unit cell is operated to realize the projected vectors with two consecutive cycles. The different locations of reference vector are associated with different output voltages and peak current values, for which a most suitable mode is selected as a part of example control scheme. Again, in each power transfer cycle, two equal but inverted half cycles can be used to ensure the HF transformer does not saturate due to net residual DC flux in the windings.

In each power transfer cycle, the most optimal mode can be selected for the desired performance. In the example embodiment, the optimal mode is selected for minimum peak current value of the transformer primary current (Iₚ). Alternatively, more detailed optimization that determines the optimal mode for additional performance parameters such as converter loss can be realized. In the example embodiment, this information was stored in a pre-calculated look up table (LUT) fetched by the mode selection block. Finally, the selected mode (mode A and B) and their respective peak current (Iₚ₁ and Iₚ₂) values over two consecutive switching cycles are utilized for PWM generation. As the reference vector I*_{ref} rotates, suitable mode is selected to realize the desired Q using UMC-unit cell achieving performance optimization over each switching-cycle. The example embodiment can also ensure zero i_{lkg} at start and end of the cycle. This completely decouples the present cycle from previous or subsequent cycles. Moreover, the AC-side is controlled to provide current source characteristics with CL filter, realizing a second-order plant that can be controlled with improved dynamic performance compared to the conventional LCL filter [21″].

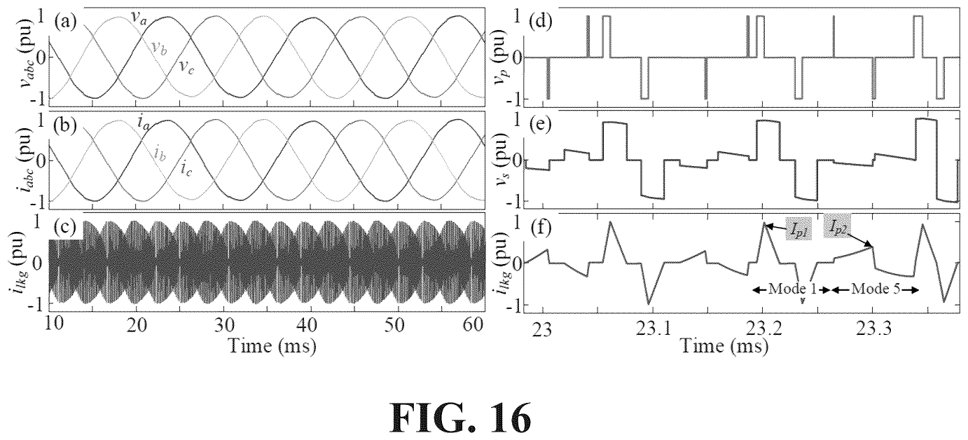

Example Simulation Results. The example control scheme was simulated for the considered three-phase DC/AC system in PLECS environment. Table IIA shows the system parameters. The control scheme essentially utilizes the three-phase SVM integrated approach with the multimode control to achieve a simple and high bandwidth control for DC/AC conversion. The simulated waveforms for the three-phase output voltages, currents and transformer primary side current are shown in FIG. 16. All the results are indicated in the per unit (p.u.) values. The sinusoidal distortion-less output voltages are obtained with the example control scheme. This is achieved with the repetitive power transfer cycle as a building block.

Further, the detailed zoomed-in view of the waveforms for transformer primary and secondary side voltages with the primary side currents are shown in FIG. 16 respectively. FIG. 16 shows that the operation of UMC over each energy transfer cycles can be independent, where i_{kg} starts and ends with zero value. Further, as can be seen from FIG. 16 that mode 1 and 5 are selected for the two consecutive cycles depending on the voltages at the input and output ports, desired Q, and lowest possible Iₚ values as Iₚ₁ and Iₚ₂, respectively. This is shown in the triangular and trapezoidal waveforms of i_{lkg} for the adjacent vectors in FIG. 16. These selected modes necessarily ensure the lowest possible peak current values for the given power transfer cycle. Further, the desired mode selection is achieved without any real-time computation by fetching the offline LUT information. In this way, the example embodiment can achieve the lowest peak current stress on the converter switches with much simpler implementation.

Table IIA shows the simulation parameters.

TABLE IIA

| Parameter | Value | | Parameter | Value | |
|---|---|---|---|---|---|
| V_{dc} | 400 | V | L_{kg} | 6 | μH |
| V_{ac, mm} | 480 | V | Nₚ:Nₛ | 1:2 | |
| C_{dc} | 100 | μF | F_{sw} | 10.9 | kHz |
| L_{f} | 6 | mH | C_{f} | 48 | μF |

Features of the example control scheme can include simplicity and/or offline information-based realization. This essentially enables the realization of bidirectional DC to three-phase AC conversion with one of the simplest possible approaches. To compare the performance of example control scheme with the existing state-of-the-art schemes, a comprehensive investigation was conducted. The analysis includes the parameters such as the peak device current and efficiency at the given power level. These parameters essentially indicate the semiconductor switch size and the overall system performance. The values for existing works are obtained from their respective published data, while the simulated values are used represent the example described herein. The simulated values consider the practical device models for the selected switching devices. The obtained values of the afore-mentioned parameters are summarized in Table IIIA for the existing as well as example approach.

Table IIIA shows a comparison of the exemplary system with existing control approaches for HF isolated DC-AC systems.

TABLE IIIA

| | Conversion | Peak | Current | | |
|---|---|---|---|---|---|
| Reference | Stage | Rated | Power | Efficiency | Control Complexity |
| [17″] | Two-stage | 1.2 | 3.0 | 95.9% | Single phase shift for DC- |
| | | | | | DC DAB + SVPWM VSI |
| | | | | | control. |
| [18″] | Two-stage | — | 10 | 94.2% | Single phase shift for DC- |
| | | | | | DC DAB + three-phase VSI |
| | | | | | control. |
| [11″] | Single-stage | 2.3 | 8.0 | 99.0% | 4 phase shift values with |
| | | | | | DCM involved. |
| [19″] | Single-stage | 4.0 | 2.0 | 90% | Real-time calculated and |
| | | | | | varying commutation |
| | | | | | sequence. |
| [20″] | Single-stage | 2.2 | 1.6 | 82.1% | Complex computation of |
| | | | | | phase-shift δ. |
| Example | Single-stage | 1.8 | 6.6 | 98.4% | LUT-stored control |
| Embodiment | | | | | parameters for real-time |
| | | | | | access. |

The example control scheme implemented with the selected DC/AC UMC provides a single-stage conversion with low control complexity, reduced peak current, and comparable efficiency values to the existing approaches. This benefits the single-stage DC/AC conversion for the cost sensitive DER-based applications.

The example embodiment of a control scheme can achieve any/all of these benefits: (A) The example multimode control scheme allows each energy transfer cycle to operate independently across an AC cycle, while realizing optimization for operating characteristics at the same time. (B) Control parameters (Iₚ and Tₘ) and mode-selection strategies are calculated offline and stored in LUT to be accessed, providing simple implementation and improving the time response of the controller. (C) The operating characteristics of UMC unit cell inherently imply minimal energy storage, as the starting and ending current of each cycle are both zero. Each power transfer cycle is thus completely decouple from previous or subsequent cycles. (D) The DC/AC realization of UMC does not rely on DC-link capacitors, requires only capacitive filters, retains better fault current behavior, and inherently reduces common-mode EMI as a current source inverter.

The study further included experimental validation of the principle of operation of the example control scheme for DC/AC conversion is presented. For the demonstration purpose, a single-phase AC system is considered. However it should be understood that a similar implementation can be realized for the three-phase system as described herein.

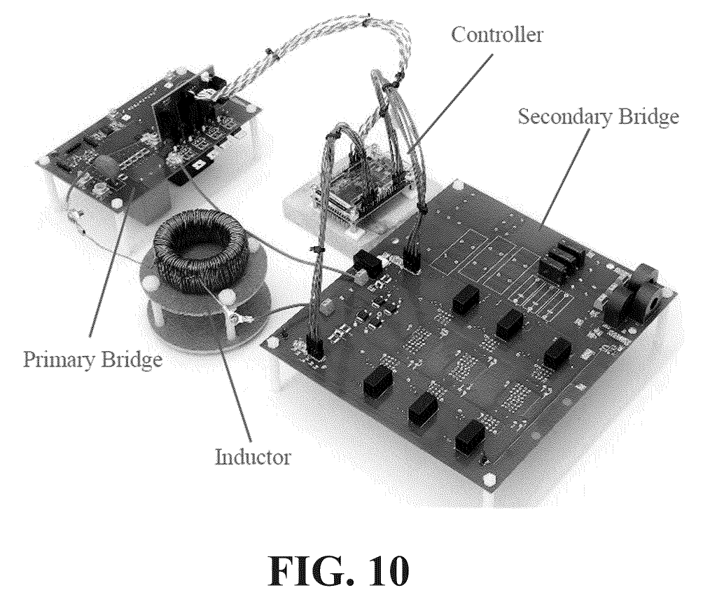

Example Hardware Implementation. To demonstrate the principle of operation of the example control scheme for the DC-AC UMC, a 2 KW hardware prototype was constructed as shown in FIG. 10. The experimental setup can include a DC bridge, an air-core leakage inductor, three-phase AC bridge and FPGA controller. The experiments were conducted with single-phase AC output by exciting only two of the legs on AC side bridge. All the gating pulses are generated using the Altera IV E FPGA connected to the isolated gate drivers of the DC and AC bridges. Table IVA lists the detailed parameters utilized for the experimental validation results

TABLE IVA

| Parameter | Value | | Parameter | Value | |
|---|---|---|---|---|---|
| Vₛ | 24 | V | L_{lkg} | 22 | μH |
| Vₒ | −24-24 | V | Nₚ:Nₛ | 1:1 | |
| C_{dc} | 30 | μF | F_{sw} | 15 | kHz |

| | | | | |
|---|---|---|---|---|
| Cₒ | 35 | uF | R_{load} | 22Ω |

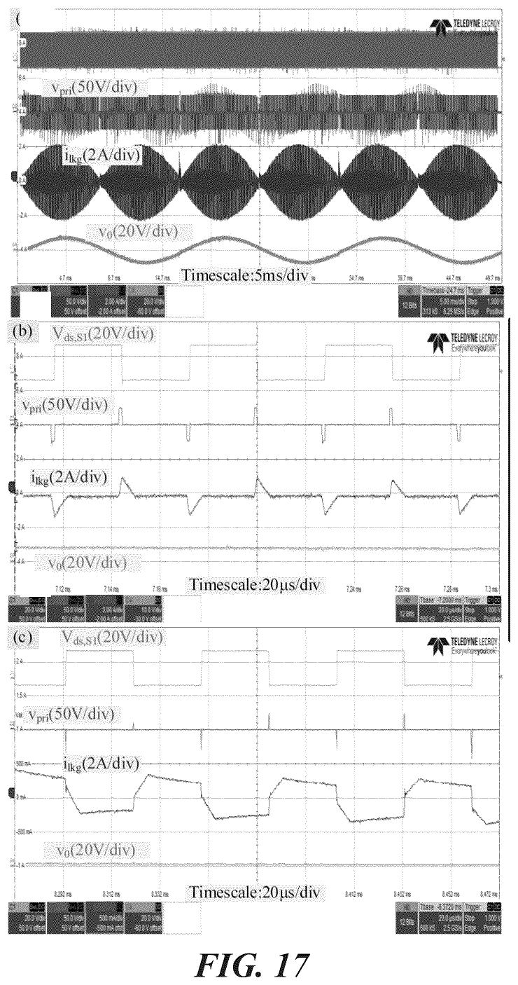

The controller generates the gating pulses for the DC and AC side switches for the desired modes to generate the reference voltage in the converter output. For this, the inner control loop (FIG. 12) receives the reference current values generated by the outer control loop (computed manually in this implementation) Finally, the example control scheme realizes the selected mode to generate the reference current values. The obtained waveforms for the operation of DC/AC UMC are shown in FIG. 17, which illustrates the waveforms for device voltage, primary-side voltage, inductor current, and output voltage. As can be seen from FIG. 17, the converter achieves sinusoidal output voltage using the example control scheme. It is to be noted that the generated output voltage is achieved through the application of desired operating mode. The two of such instances are depicted in FIG. 17, showing the realized operation in mode 1 and 2. In similar manner, other modes are utilized in the example control scheme to deliver the desired amount of change over each power transfer cycle at lowest peak current. This validates the operation of the UMC DC/AC converter with multimode control scheme.

Discussion. The example embodiment includes a multimode control scheme-based universal minimal cell (UMC) realization of a isolated, bi-directional, and single-stage three-phase DC/AC converter. Example 1 presented the operating principles of UMC unit cell and the multimode control approach, which can be extended to various types of power conversion. The example embodiment described herein has reduced the operation of considered configuration to a simpler and independent ‘power transfer cycles,’ to offer an enhanced flexibility in overall system control. The study showed that a controlled amount of charge can be transferred from one DC or AC port to another, even when the terminal voltages and current can vary widely, on a switching cycle basis. In the present example, the example control scheme was extended to a DC-AC converter realization with AC modulation approaches. This realizes a simple control structure as the multimode control parameters and analytics are offline and stored in LUTs to be accessed in real-time, to achieve high-performance dynamic control and to optimized objective functions at the same time. Further, the example approach achieved mitigation of transformer saturation issue, minimization of the energy storage element and reduction of the peak current stress on the switching devices.

The presented discussion and simulation results highlight the features of the example embodiment of the present disclosure for the three-phase DC/AC conversion. A dedicated 2 kW prototype has been constructed to validate the benefits of the example control scheme. Two-quadrant operation was verified by the experimental results, and the realized DC to AC operation validates the functionality of the example control scheme. The study shows that full DC to three-phase AC operation with the example space-vector modulation at high power levels can be achieved by embodiments of the present disclosure.

Discussion. Distributed energy resources (DERs), such as solar PV, EVs, energy storage and green hydrogen, are seeing exponential growth across the world [1″]. DER integration can require high-performance power converters to connect a multitude of DC sources and loads (e.g., PV, batteries, electrolysis etc.) to the grid [2″]-[4″]. Energy flow can be frequently bidirectional, and galvanic isolation is often required [5″]. Existing power converters can include a high frequency (HF) link-based DC/DC stage, such as the Dual Active Bridge (DAB) converter [6″]-[8″]. Further, depending on the DC or AC interface, additional AC/DC and DC/AC stages are added on either side of the DAB structure [9″], [10″]. In such scenarios, multiple conversion stages and the need for intermediate energy storage lead to higher cost and size of the converter, poor efficiency due to higher switching losses, and limited dynamic response.

The control of existing single-stage DC/AC converters is based on the complex phase-shift relationships, which also depend on the specific operating point, sometimes including continuous and discontinuous conduction modes [11″], [12″], [14″]. This makes the realization of closed-loop predictable transfer characteristic difficult and creates challenges for stable operation in grid-connected multi-inverter systems [15″]. Further, the wide variation of voltage across the HF-link in a single-stage DC/AC conversion can result in high peak currents causing higher device losses. Moreover, sensing and control delays may cause transformer saturation requiring the use of series capacitors. This further adds losses in the system [11″]. Therefore, though the HF link single-stage three-phase DC/AC configurations can have benefits from a minimal topology perspective, an overall high-performance control approach that is practical and cost effective is still needed.

As described herein, embodiments of the present disclosure include a Universal Minimal Converter (UMC), that can be used to realize a wide range of power conversion functions by using a multimode control of the basic UMC-unit cell [16″]. Unlike phase shift control techniques, multimode control of the UMC cell is based on a deadbeat control strategy and offline analytics. Further, the results can optionally be stored in a lookup table, which can be accessed in real-time, it achieves high-performance dynamic control with the capability to optimize desired objective functions. This approach can reduce the peak current stress at the UMC cell level by as much as 4:1. The present example shows that the UMC cell and optimization strategy can be used with more complex HF link bidirectional single-stage DC/AC and AC/AC converters, with particular attention on DC to multiphase AC converters. The example DC/AC converter realization of UMC utilizing the multimode control structure was demonstrated in this study, where optimum switching modes were selected for the converter on a switching-cycle basis, achieving both simple plant-level control and optimum device switching at the same time.

### Example Computing Device

The methods described herein can be implemented using a computing device. It should be understood that the example computing device described herein is only one example of a suitable computing environment upon which the methods described herein may be implemented. Optionally, the computing device can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device typically includes at least one processing unit and system memory. Depending on the exact configuration and type of computing device, system memory may be volatile (such as random access memory (RAM), non-volatile (such as read-only memory (ROM), flash memory, etc.), or some combination of the two. The processing unit may be a standard programmable processor that performs arithmetic and logic operations necessary for the operation of the computing device. The computing device may also include a communication bus or other communication mechanism for communicating information among various components of the computing device.

Computing device may have additional features/functionality. For example, computing device may include additional storage such as removable storage and non-removable storage, including, but not limited to, magnetic or optical disks or tapes. Computing device may also contain network connection(s) that allow the device to communicate with other devices. Computing device may also have input and output means such as a keyboard, mouse, touch screen, a display, speakers, printer, etc. The additional devices may be connected to the communication bus in order to facilitate the communication of data among the components of the computing device. All these devices are well-known in the art and need not be discussed at length here.

The processing unit may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example of tangible, computer-readable media may include, but is not limited to, volatile media, non-volatile media, removable media, and non-removable media implemented in any method or technology for storage of information such as computer-readable instructions, data structures, program modules or other data. System memory, removable storage, and non-removable storage are all examples of tangible, computer storage media. Examples of tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit may execute program code stored in the system memory. For example, the communication bus may carry data to the system memory, from which the processing unit receives and executes instructions. The data received by the system memory may optionally be stored on the removable storage or the non-removable storage before or after execution by the processing unit.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

It should be appreciated that the logical operations described above and, in the appendix, can be implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, acts, or modules. These operations, acts and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

### Other Examples

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or other organism, living or dead, or other biological or molecular structure or chemical environment, and may relate to particular components of the subject, for instance, specific tissues or fluids of a subject (e.g., human tissue in a particular area of the body of a living subject), which may be in a particular location of the subject, referred to herein as an “area of interest” or a “region of interest.”

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications, and publications, as listed below and throughout this document, are hereby incorporated by reference in their entirety herein.

### Reference List #1

[1] M. N. Kheraluwala, R. W. Gascoigne, D. M. Divan and E. D. Baumann, “Performance characterization of a high-power dual active bridge DC-to-DC converter,” in IEEE Transactions on Industry Applications, vol. 28, no. 6, pp. 1294-1301 Nov.-Dec. 1992.
[2] H. Chen and D. Divan, “Soft-Switching Solid-State Transformer (S4T),” in IEEE Transactions on Power Electronics, vol. 33, no. 4, pp. 2933-2947 Apr. 2018.
[3] A. Kanale et al., “Design Considerations for Developing 1.2 kV 4H-SiC BiDFET-enabled Power Conversion Systems,” 2022 IEEE Energy Conversion Congress and Exposition (ECCE), Detroit, MI, USA, 2022, pp. 1-7
[4] L. Gyugyi and F. Cibulka, “The High-Frequency Base Converter-A New Approach to Static High-Power Conversion,” in IEEE Transactions on Industry Applications, vol. IA-15, no. 4, pp. 420-429, Jul. 1979.
[5] V. T. Ranganathan, P. D. Ziogas and V. R. Stefanovic, “A Regulated DC-DC Voltage Source Converter Using a High Frequency Link,” in IEEE Transactions on Industry Applications, vol. IA-18, no. 3, pp. 279-287, May 1982.
[6] L. Schrittwieser, M. Leibl and J. W. Kolar, “99% Efficient Isolated Three-Phase Matrix-Type DAB Buck-Boost PFC Rectifier,” in IEEE Transactions on Power Electronics, vol. 35, no. 1, pp. 138-157, Jan. 2020.

### Reference List #2

[1′] K. Horowitz et al., “An overview of distributed energy resource (DER) interconnection: current practices and emerging solutions.” United States: N. p., 2019, Accessed Jul. 20, 2023.
[2′] M. Wang, Q. Huang, W. Yu and A. Huang, “An isolated bi-directional soft-switched DC-AC converter using wide-band-gap devices with novel carrier-based unipolar modulation technique under synchronous rectification,” in Proc. IEEE Appl. Power Electron. Conf. Expo. (APEC), Charlotte, NC, USA, 2015, pp. 2317-2324.
[3′] Z. An, X. Han, V. R. Chowdhury, J. Benzaquen, R. Kandula and D. Divan, “A tri-port current-source soft-switching medium-voltage string inverter for large-scale solar-plus-storage farms,” IEEE Trans. Power Electron., vol. 37, no. 11, pp. 13808-13823, Nov. 2022.
[4′] S. Belkhode, J. Benzaquen, and D. Divan, “An integrated bidirectional tri-port microconverter for hybrid solar plants,” IEEE Energy Conversion Congress and Exposition (ECCE), Nashville, TN, USA, Oct.-Nov., 2023, in press.
[5′] M. H. Kheraluwala, R. W. Gasgoigne, D. M. Divan and E. Bauman, “Performance characterization of a high power dual active bridge DC/DC converter,” Conference Record of the 1990 IEEE Industry Applications Society Annual Meeting, Seattle, WA, USA, 1990, pp. 1267-1273 vol.2.
[6′] S. Belkhode, G. Ratanpuri, S. Mandal, A. Shukla and S. Doolla, “Investigation of the five-level hybrid active NPC-based dual-activebridge converter for EV battery charging applications,” in Proc. IEEE Energy Conversion Congress and Exposition (ECCE), Detroit, MI, USA, 2022, pp. 1-7.
[7′] G. Ratanpuri, S. Belkhode and A. Shukla, “A novel five-level hybrid dual active bridge converter with optimized switching principle,” in Proc. IEEE Applied Power Electronics Conference and Exposition (APEC), Houston, TX, USA, 2022, pp. 2092-2097.
[8′] M. Sayed, K. Suzuki, T. Takeshita and W. Kitagawa, “PWM switching technique for three-phase bidirectional grid-tie DCACAC converter with high-frequency isolation,” IEEE Trans. Power Electron., vol. 33, no. 1, pp. 845, Jan. 2018.
[9′] Y. Shi, R. Li, Y. Xue and H. Li, “High-Frequency-Link-Based Grid-Tied PV System With Small DC-Link Capacitor and Low-Frequency RippleFree Maximum Power Point Tracking,” IEEE Trans. Power Electron., vol. 31, no. 1, pp. 228-239, Jan. 2016.
14^{th} [10′] Y. Cho, W. Cha, J. Kwon and B. Kwon, “High-efficiency bidirectional DAB inverter using a novel hybrid modulation for stand-alone power generating system with low input voltage,” IEEE Trans. Power Electron., vol. 31, no. 6, pp. 4138-4147 Jun. 2016.
14^{th} [11′] S. Khan, M. Rashid and P. Ziogas, “Analysis and design of improved three to single phase cycloconverter,” in Proc. Annual Conference of Industrial Electronics Society, Singapore, 1988, pp. 603-610.
[12′] L. Zheng, R. Kandula and D. Divan, “Soft-switching solid-state transformer with reduced conduction loss,” IEEE Trans. Power Electron, vol. 36, no. 5, pp. 5236-5249 May. 2021.
[13′] H. Dai, T. Jahns, R. Torres, D. Han and B. Sarlioglu, “Comparative evaluation of conducted common-mode EMI in voltage-source and current-source inverters using wide-bandgap switches,” in Proc. IEEE Transportation Electrification Conference and Expo (ITEC), Long Beach, CA, USA, 2018, pp. 788-794.
[14′] Muniappan, M. “A comprehensive review of DC fault protection methods in HVDC transmission systems.” in Proc. Prot. Control Mod. Power Syst. 6,1 (2021).
[15′] L. Schrittwieser, M. Leibl and J. Kolar, “99% efficient isolated threephase matrix-type DAB buck-boost PFC rectifier,” IEEE Trans. Power Electron., vol. 35, no. 1, pp. 138-157, Jan. 2020.
[16′] Y. Mei, Z. Liu and W. Huang, “A coordination control strategy for an isolated bidirectional AC/DC matrix converter,” in Proc. 22nd International Conference on Electrical Machines and Systems (ICEMS), Harbin, China, 2019, pp. 1-5.
[17′] D. Varajão, R. E. Araújo, L. Miranda and J. Lopes, “Modulation strategy for a single-stage bidirectional and isolated AC-DC matrix converter for energy storage systems,” IEEE Trans. Ind. Electron, vol. 65, no. 4, pp. 3458-3468 Apr. 2018.
[18′] R. Hao, S. Belkhode, J. Benzaquen, and D. Divan, “Multimode control of HF link universal minimal converters—Part II: multiphase AC systems,” in Proc. IEEE Energy Convers. Congr. Expo., Nashville, USA, 2023, in press.

### Reference list #3

[1″] F. Blaabjerg, R. Teodorescu, M. Liserre and A. V. Timbus, “Overview of control and grid synchronization for distributed power generation systems,” IEEE Trans. Ind. Electron., vol. 53, no. 5, pp. 1398-1409 Oct. 2006.
[2″] J. M. Carrasco et al., “Power-electronic systems for the grid integration of renewable energy sources: A survey,” IEEE Trans. Ind. Electron., vol. 53, no. 4, pp. 1002-1016 Jun. 2006.
[3″] Y. Shi, R. Li, Y. Xue and H. Li, “High-frequency-link-based grid-tied PV system with small DC-link capacitor and low-frequency ripple-free maximum power point tracking,” IEEE Trans. Power Electron., vol. 31, no. 1, pp. 228-239, Jan. 2016.
[4″] Z. An, X. Han, V. R. Chowdhury, J. Benzaquen, R. P. Kandula and D. Divan, “A tri-port current-source soft-switching medium-voltage string inverter for large-scale solar-plus-storage farms,” IEEE Trans. Power Electron., vol. 37, no. 11, pp. 13808-13823, Nov. 2022.
[5″] L. Zheng et al., “ 7.2 kV three-port SiC single-stage current-source solidstate transformer with 90 kV lightning protection,” IEEE Trans. Power Electron., vol. 37, no. 10, pp. 12080-12094, Oct. 2022.
[6″] S. Belkhode, G. Ratanpuri, S. Mandal, A. Shukla and S. Doolla, “Investigation of the five-level hybrid active NPC-based dual-activebridge converter for EV battery charging applications,” in Proc. IEEE Energy Conversion Congress and Exposition (ECCE), Detroit, MI, USA, 2022, pp. 1-7.
[7″] G. Ratanpuri, S. Belkhode and A. Shukla, “A novel five-level hybrid dual active bridge converter with optimized switching principle,” in Proc. IEEE Applied Power Electronics Conference and Exposition (APEC), Houston, TX, USA, 2022, pp. 2092-2097.
[8″] M. H. Kheraluwala, R. W. Gasgoigne, D. M. Divan and E. Bauman, “Performance characterization of a high power dual active bridge DC/DC converter,” in Proc. IEEE Industry Applications Society Annual Meeting, Seattle, WA, USA, 1990, pp. 1267-1273 vol.2.
[9″] V. K. Kanakesh, D. B. Yelaverthi, A. Ghoshal, A. K. Rathore and R. Mahanty, “Analysis and implementation of closed-loop control of electrolytic capacitor-less six-pulse DC-link bidirectional three-phase grid-tied inverter,” IEEE Trans. Ind. Appl., vol. 54, no. 1, pp. 539-550, Jan.-Feb. 2018.
[10″] Y. Shi, R. Li, Y. Xue and H. Li, “High-frequency-link-based grid-tied PV system with small DC-link capacitor and low-frequency ripple-free maximum power point tracking,” IEEE Trans. Power Electron., vol. 31, no. 1, pp. 228-239, Jan. 2016.
[11″] L. Schrittwieser, M. Leibl and J. W. Kolar, “99% efficient isolated threephase matrix-type DAB buck-boost PFC rectifier,” IEEE Trans. Power Electron., vol. 35, no. 1, pp. 138-157, Jan. 2020.
[12″] S. Belkhode, J. Benzaquen, and D. Divan, “An integrated bidirectional tri-port microconverter for hybrid solar plants,” in IEEE Energy Conversion Congress and Exposition (ECCE), Nashville, TN, USA, Oct.-Nov. 2023, in press.

[13″] J. Afsharian, D. Xu, B. Wu, B. Gong and Z. Yang, “The optimal PWM modulation and commutation scheme for a three-phase isolated buck matrix-type rectifier,” IEEE Trans. Power Electron., vol. 33, no. 1, pp. 110-124, Jan. 2018.
[14″] X. Li, F. Wu, G. Yang, H. Liu and T. Meng, “Dual-period-decoupled space vector phase-shifted modulation for DAB-based three-phase single-stage AC-DC converter,” IEEE Trans. Power Electron., vol. 35, no. 6, pp. 6447-6457 Jun. 2020.
[15″] P. M. Gajare, M. Miranbeigi, J. Benzaquen, P. Kandula and D. Divan, “Understanding the interactions in systems with multiple types of gridforming inverters,” in Proc. IEEE 13th International Symposium on Power Electronics for Distributed Generation Systems (PEDG), Kiel, Germany, 2022, pp. 1-6.
[16″] R. Hao, S. Belkhode, J. Benzaquen, and D. Divan, “Multimode control of HF link universal minimal converters-Part I: Principles of operation,” in Proc. IEEE Energy Convers. Congr. Expo., Nashville, USA, 2023, in press.
[17″] S. Wei et al, “Design and implementation of high efficient two-stage three-phase/level isolated PV converter,” in Proc. 18th International Conference on Electrical Machines and Systems (ICEMS), Pattaya, Thailand, 2015, pp. 1649-1654.
[18″] Y.-S. Noh, D. Joo, B. J. Hyon, J. S. Park, J.-H. Kim and J.-H. Choi, “Development of 3-phase current-fed dual active bridge converter for bi-directional battery charger application,” in Proc. IEEE Energy Conversion Congress and Exposition (ECCE), Detroit, MI, USA, 2020, pp. 2287-2290.
[19″] K. Sumiya, Y. Naito, J. Xu, N. Shimosato and Y. Sato, “An advanced commutation method for bidirectional isolated three-phase AC/DC dualactive-bridge converter based on matrix converter,” in Proc. IEEE Energy Conversion Congress and Exposition (ECCE), Detroit, MI, USA, 2020, pp. 4158-4164.
[20″] D. Das, N. Weise, K. Basu, R. Baranwal and N. Mohan, “A bidirectional soft-switched DAB-based single-stage three-phase AC-DC converter for V2G application,” IEEE Trans. Transport. Electrific., vol. 5, no. 1, pp. 186-199, Mar. 2019.
[21″] P. M. Gajare, J. Benzaquen, and D. Divan, “On the passivity and stability of grid-forming voltage-source and current-source inverters,” in Proc. IEEE Energy Conversion Congress and Exposition (ECCE), Nashville, TN, USA, Oct.-Nov. 2023, in press.

What is claimed:

1. A power converter comprising:
a power converter circuit comprising a plurality of switches and an energy transfer device;
a controller operably coupled to the power converter circuit, the controller configured to:
determine operation of a unit cell defined by the plurality of switches or a portion thereof, the unit cell comprising first side switches and second side switches coupled together by the energy transfer device;
select, from a pre-defined set of modes, a mode for a cycle that transfers a controlled charge and energy between the first side and the second side, each mode of the pre-defined set of modes having a unique combination of a plurality durations for energy transfer for a corresponding transfer condition;
determine operation of the plurality of switches from the selected mode; and
control the plurality of switches to operate the converter circuit according to the selected mode on a cycle-by-cycle basis, wherein a transition from a current cycle to a next cycle occurs when there is no residual energy in the energy transfer device.

2. The power converter of claim 1, wherein the controller is configured to select the mode according to a pre-defined set of sequences based on different operating conditions of the energy transfer.

3. The power converter of claim 2, wherein the selection is based on state logic.

4. The power converter of claim 1, wherein the unit cell comprises a dual active bridge, wherein a primary voltage and a secondary voltage of the active bridges are switched by action of the first side switches and the second side switches.

5. The power converter of claim 1, wherein each mode of the pre-defined set of modes has a unique combination of a plurality durations for energy transfer for a corresponding transfer condition defined by a geometric waveform defined by the plurality durations and the transfer condition.

6. The power converter of claim 2, wherein the pre-defined set of sequences comprises analytical formulation for the different operating conditions, including at least one of output current, switching period, rms currents, and device losses.

7. The power converter of claim 1, wherein each cycle is self-contained and decoupled from another cycle.

8. The power converter of claim 1, wherein the modes are selected for minimization of peak current, and wherein each mode comprises a unique combination of a plurality durations for energy transfer for a corresponding transfer condition comprising peak current of the energy transfer.

9. The power converter of claim 1, wherein the power converter circuit is configured as a universal minimal converter.

10. The power converter of claim 1, wherein the unit cell is universally configurable and reconfigurable as an AC/DC converter, a DC-DC converter, and a DC/AC converter, and wherein the controller and power converter circuit are configurable and reconfigurable as an AC/DC converter, a DC-DC converter, and a DC/AC converter.

11. A method comprising:
determining operation of a unit cell defined by the plurality of switches or a portion thereof of a power converter circuit comprising a plurality of switches and an energy transfer device, the unit cell comprising first side switches and second side switches coupled together by the energy transfer device;
selecting, from a pre-defined set of modes, a mode for a cycle that transfers a controlled charge and energy between the first side and the second side, each mode of the pre-defined set of modes having a unique combination of a plurality durations for energy transfer for a corresponding transfer condition; and
determining operation of the plurality of switches from the selected mode; and
controlling the plurality of switches to operate the converter circuit according to the mode on a cycle-by-cycle basis, wherein a transition from a current cycle to a next cycle occurs when there is no residual energy in the energy transfer device.

12. The method of claim 11, wherein the selecting of the mode is according to a pre-defined set of sequences based on different operating conditions of the energy transfer.

13. The method of claim 12, wherein the selection is based on state logic.

14. The method of claim 11, wherein the unit cell comprises a dual active bridge, wherein a primary voltage and a secondary voltage of the active bridges are switched by action of the first side switches and the second side switches.

15. The method of claim 11, wherein each mode of the pre-defined set of modes has a unique combination of a plurality durations for energy transfer for a corresponding transfer condition defined by a geometric waveform defined by the plurality durations and the transfer condition.

16. The method of claim 12, wherein the pre-defined set of sequences comprises analytical formulation for the different operating conditions, including at least one of output current, switching period, rms currents, and device losses.

17. The method of claim 11, wherein the modes are selected for minimization of peak current, and wherein each mode comprises a unique combination of a plurality durations for energy transfer for a corresponding transfer condition comprising peak current of the energy transfer.

18. The method of claim 11, wherein the power converter circuit comprises a transformer as the energy transfer device.

19. The method of claim 11, wherein the unit cell is universally configurable and reconfigurable as an AC/DC converter, a DC-DC converter, and a DC/AC converter, and wherein the controller and power converter circuit are configurable and reconfigurable as an AC/DC converter, a DC-DC converter, and a DC/AC converter.

20. A non-transitory computer readable medium having instruction stored thereon, wherein execution of the instructions by a processor causes the processor to:
determine operation of a unit cell defined by the plurality of switches or a portion thereof of a power converter circuit comprising a plurality of switches and an energy transfer device, the unit cell comprising first side switches and secondary side switches coupled together by the energy transfer device;
select, from a pre-defined set of modes, a mode for a cycle that transfers a controlled charge and energy between the first side and the second side, each mode of the pre-defined set of modes having a unique combination of a plurality durations for energy transfer for a corresponding transfer condition; and
determine operation of the plurality of switches from the selected mode; and controlling the plurality of switches to operate the converter circuit according to the mode on a cycle-by-cycle basis, wherein a transition from a current cycle to a next cycle occurs when there is no residual energy in the energy transfer device.
